(19) United States
(12) Patent Application Publication
(10) Pub. No.: US 2016/0379299 A1
(43) Pub. Date: Dec. 29, 2016

(54) Systems and Methods for Automatic Brokering of Properties

(71) Applicant: Realster LLC, New York, NY (US)

(72) Inventors: Parham Alizadeh, New York, NY (US); Valla Fatemi, Cambridge, MA (US); Evert-Jan Wamsteker, New York, NY (US)

(21) Appl. No.: 14/834,745

(22) Filed: Aug. 25, 2015

Related U.S. Application Data
(63) Continuation-in-part of application No. 14/753,898, filed on Jun. 29, 2015.

(51) Int. Cl. G06Q 30/06; G06Q 50/16; G06Q 50/18

(52) U.S. Cl. CPC G06Q 30/0645; G06Q 50/188; G06Q 50/163

(57) ABSTRACT

A system and method for better allocation of rental properties and matching of tenants and properties, especially in a competitive marketplace, is presented. In some aspects, an automated system processes prospective applicant renter applications, refines and unifies property listings, and automatically generates recommendations of tenant-property matches according to a fair, economic model including bids or offers by tenants on properties for which they qualify. The system and method permits stress-free and organized and uniform viewing of the properties and bidding/making offers on the same without chaotic and unfair first-come-first-served practices and other unfair leasing practices found in the industry. Also, fair market pricing is more easily achieved, which gives feedback to lessors. In addition, uniform executable lease agreements are generated according to the results of the matching process.

### TECHNICAL FIELD

The present application is directed to automated brokering of rental properties, including computer-based systems and methods for automatically generating recommendations of tenant-property matches.

### RELATED APPLICATIONS

This application is a continuation-in-part of U.S. patent application Ser. No. 14/753,898 entitled “Landlord-Tenant-Property Matching System and Matrix”, filed on Jun. 29, 2015, which is hereby incorporated by reference.

### BACKGROUND

Tenants and landlords have long sought mutually-beneficial relationships. Tenants seek appropriate housing for themselves and their families whereby they pay rent to the owner of the housing (e.g., a house or apartment) to occupy the dwelling under certain terms and for a certain duration. Landlords seek tenants who will take appropriate care of their property while living in it and pay their rent amounts on time as agreed. Tenants and landlords execute a lease, which is a legal contract laying out the terms of the tenancy, its duration, the amount of rent and other terms as appropriate.

In some geographic areas there is an abundance of rental units or dwellings (or commercial spaces) available, which favors the tenant in a supply-and-demand situation. In other geographic areas (e.g. congested urban areas like New York City) there tends to be a shortage of affordable, high quality residential rental space. This latter situation lends itself to a chaotic system for locating a residential dwelling to rent. Potential tenants scramble between open houses on their days off from work to view and decide on a new apartment to rent only to return and find that another potential renter has entered into a lease on their choice already. Available apartments can become the subject of intense competition among potential renters to secure a lease on the same. Persons looking to rent an apartment are often frustrated by this and may be tempted to sign a lease for the first open apartment that minimally meets their needs instead of having the security of visiting and considering multiple units before making an offer to rent a selected one. Also, tenants may be tempted to lie or exaggerate facts on their application for an apartment to as to secure the apartment, leaving the landlord with a tenant that may not fully meet the landlord's needs for the unit. Brokers are persons who charge fees to a landlord and/or tenant in exchange for finding an apartment for a tenant or a tenant for a landlord. Broker fees in cities with scarce availability of space can be quite high and costly to landlords and/or tenants.

Traditional matching of tenants, landlords and properties has been handled through real estate listing offices, newspaper listings, bulletin boards, word of mouth, or other conventional means. Brokers are often used, especially in high-demand locations, to facilitate the introduction of prospective renters to owners of properties that meet the needs of the renters. More recently, online sites and mobile device apps exist for listing open rental units and for providing other services to landlords and tenants. Examples are offerings from Zillow, Street Easy, Trulia, Urban Compass, Cozy, and others.

FIG. 1 depicts a typical scenario 10 for finding and signing leases for residential property, especially in urban environments. Landlord 120 owns one or more properties 102, 104, 106, which are in this example rental units available for leasing (e.g., as residential or commercial accommodations).

The process of finding tenants to lease rental units 102, 104, 106, including the listing of rental units 102, 104, 106 in a directory or database of available properties for lease is often handled by a broker 110 who may be retained by landlord 120. One responsibility of the broker 110 is usually to place a printed or electronic advertisement 140 in a specialized publication or database listing the units (represented in listing 140 property listing data 102′, 104′, 106′). The listing 140 can conventionally include a printed publication, e.g., Sunday paper classified section, special magazine for people relocating to a new city, and so on. The listing 140 can also be a posting in an electronic database or online advertising or classified service, e.g. Craigslist™, rent.com, a web page of a real estate agency, or myriad other online services for finding rental properties. The point being that tenants (with or without a subscription to listing 140) can access the contents or see the listed information therein.

Prospective tenants 132, 134, 136 seeking to lease a unit thus obtain listing 140 and review property listing data 102′, 104′, 106′ representing the available units 102, 104, 106, respectively. If a given tenant 136 is interested in leasing a given rental unit 102, listed in listing 140 by its property listing data 102′, tenant 136 can contact broker 110 with regard to the desired unit 102. Tenant 136 and broker 110 may arrange an in-person showing of the unit (or others) and tenant 136 may enter into an agreement (lease) 150 with landlord or owner 120. The role played by broker 110 varies, and a management company employing broker 110 sometimes handles all of the lease arrangements and may even be authorized to execute lease agreement 150 with tenant 136.

Alternatively, broker 110 is merely a conduit for introducing tenant 136 and owner 120 to each other and the parties then execute lease 150 directly on their own. Broker 110 is typically compensated by the landlord 120 or tenant 136, which compensation may be in the form of a percentage of the lease value (e.g., a month's rent, or up to 15% of the lease value or more). In other instances, tenants 132, 134, 136 may employ an agent or broker themselves, who in limited circumstances may be the same as broker 110 retained by owner 120.

Some listings and brokers act as aggregators of listing information. For example, the major classified sites and local newspapers and magazines aggregate listing data from a plurality of property owners, apartment complexes, realty companies, or from a plurality of listing agents. Such aggregators merely multiply the number of options in the marketplace, but do not simplify or streamline or solve any of the existing problems in the rental market.

The above example illustrates how the traditional renting process is cumbersome, involves several parties that must coordinate their schedules and interests, and can involve competition among landlords and tenants for available rental properties. Tenants are pressed to pay high rents and high broker fees and to sign leases for properties that might not be ideal for their needs and budgets had they had a more transparent and fair opportunity to carry out better diligence in their search for a residence. Current systems are often first-come-first-served where the first tenant to agree to a lease and make a deposit on a property is awarded the lease in a competitive market where demand for properties is high. Landlords are also prone to signing with a tenant before having an opportunity to reasonably vet a variety of tenants, thus missing out on a better tenant or lease opportunity.

Another general problem with conventional systems and methods is that the pricing of rental properties is not efficient in the economic sense and that pricing is anecdotal, based on best estimates or trial-and-error, averaging of so-called comparables, and so on. Yet another limitation of the traditional rental markets and systems is that excessive broker/aggregator/agent fees are imposed on both lessors (landlords, owners) and lessees (renters, tenants). Still another limitation of existing rental marketplaces is that there is no standardized way for achieving a final lease outcome between disparate landlords, brokers, listing services and tenant pools.

In all, a better solution for matching landlords, tenants and rental properties is needed, including a solution that creates an efficient marketplace for rental property, has better inventory allocation, and reduces the stress and chaos currently existing in the residential (and commercial) rental markets.

### SUMMARY

Some implementations of the present system and method may better optimize the rental process for lessors and/or lessees, for example by improving the efficiency of the rental process and more optimally and fairly allocating rental properties at efficient prices. Aspects of the present invention or inventions provide a more efficiently priced rental marketplace, including a standardized way for multiple interested lessees to compete for a desired property without the stress, unfairness and inefficiency first-come-first-serve models used in the conventional marketplace.

One embodiment hereof is directed to a method for automatically brokering available rental properties to tenant applicants applying to lease said properties, comprising receiving landlord information for at least one landlord seeking to rent an available property through a landlord interface of a server, and recording said landlord information in a landlord data matrix in a data store of said server; in response to a request from a tenant applicant, automatically providing property information to said tenant applicant through a tenant applicant interface of said server, said property information including data representing an available property to be rented, said property information formatted into a common listing format; through said tenant applicant interface of said server, receiving a tenant applicant bid or offer from said tenant applicant, said tenant applicant bid including an offer rental price, an offer rental start date, and an offer lease duration and recording said tenant applicant bid in a tenant data matrix in said data store of said server; automatically transmitting said tenant applicant bid to said landlord through said landlord interface of said server; through said landlord interface of said server, receiving (a) a landlord acceptance of said tenant applicant bid or (b) a landlord counteroffer to said tenant applicant bid, said landlord counteroffer including at least one of a counteroffer rental price, a counteroffer rental start date, and a counteroffer lease duration; if said server receives said landlord counteroffer from said landlord, automatically transmitting said landlord counteroffer to said tenant applicant through said tenant applicant interface of said server; and if said server receives said landlord acceptance from said landlord, automatically generating a leasing document and sending said leasing document to said landlord and said tenant applicant through said landlord interface and said tenant applicant interface, respectively.

Another embodiment is directed to a method for automatically brokering available rental properties to tenants applying to lease said properties, comprising receiving landlord information from a landlord seeking to rent an available property through a landlord interface of a server, and recording said landlord information in a landlord data matrix in a data store of said server; receiving property information containing data representing at least one available property to be rented and formatting said property information into a common listing format; receiving tenant applicant information for registered tenant applicants seeking to rent an available property through a tenant applicant interface of said server, including receiving a tenant-property preference list representing an ordered preference ranking of available properties for each registered tenant applicant; receiving tenant applicant bids on each of a plurality of available properties in said tenant-property preference list, and recording said tenant applicant information and tenant-property preference lists in a tenant applicant data matrix in said data store of said server; in said server, ranking said registered tenant applicants and said available properties comprising comparing a plurality of qualified bids by a plurality of registered tenant applicants on a same available property and comparing said same available property in respective tenant-property preference lists of said plurality of registered tenant applicants so as to generate a ranked registered tenant applicant list; sending said ranked registered tenant applicant list to said landlord through said landlord interface of said server; through said landlord interface of said server, receiving (a) a landlord acceptance of a first qualified bid made by a first registered tenant applicant for said available property, said first registered tenant having a ranking in said ranked registered tenant list or (b) a landlord counteroffer to said first qualified bid, said landlord counteroffer including at least one of a counteroffer rental price, a counteroffer rental start date, and a counteroffer lease duration.

Another embodiment is directed to a system for automatic brokering of properties, comprising a server having at least one processing circuit configured and adapted to execute machine readable instructions, a digital data store coupled to said processing circuit configured and adapted to store said machine readable instructions and data for processing in said processing circuit; a landlord interface, having a first port coupled to said server and a second port coupled to an external communication layer available to said landlords, and further configured using machine readable instructions and executed in said processing circuit, and further configured and adapted to receive landlord information containing data identifying a registered landlord who owns at least one available rental property and for receiving property information containing data representing attributes of said available rental property; a tenant interface, having a first port coupled to said server and a second port coupled to an external communication layer available to said registered tenant, said tenant interface configured and adapted to receive tenant information containing data identifying a registered tenant who seeks a rental property and for receiving attributes of properties that said registered tenant is seeking; a communication interface coupling said server to said registered landlord through said landlord interface, and coupling said server to said registered tenant through said tenant interface; a landlord data matrix comprising digitally stored and formatted landlord information in said digital data store, said landlord information identifying said registered landlord as well as other landlord information corresponding to said registered landlord; a tenant data matrix comprising digitally stored and formatted tenant information in said digital data store, said tenant information identifying a registered tenant, a tenant-property preference list, bid data containing bids by said tenant for at least one property, and other tenant information corresponding to said registered tenant; a formatting module of said processing circuit configured and adapted to format said property information for said available property from a first format to a second format and having an input receiving said property in said first format and an output providing said property information in said second format as a common property listing for said available property; a ranking module of said processing circuit configured and adapted to receive at least a portion of said property information and at least said bid data from a plurality of registered tenants, and to determine a ranked allocation of resources where said plurality of registered tenants compete for a same available property, said ranking module further being configured and adapted to provide an output representing a rank registered tenant list of registered tenants and properties; a document generation module of said processing circuit configured and adapted to automatically output respective documents for each registered tenant allocating to them respective leases to corresponding respective properties on which they have successfully bid; and a real-time communication module of said processing circuit configured and adapted to send and receive negotiation messages in real time between a negotiating landlord and a negotiating tenant through said communication interface.

### IN THE DRAWINGS

For a fuller understanding of the nature and advantages of the present invention, reference is made to the following detailed description of preferred embodiments and in connection with the accompanying drawings, in which:

FIG. 1 illustrates a conventional property leasing arrangement;

FIG. 2 illustrates an exemplary arrangement of a system for matching landlords, tenants and rental properties according to the present method;

FIG. 3 illustrates an exemplary tenant-property bid matrix;

FIG. 4 illustrates an exemplary tenant-property ranking matrix;

FIG. 5 illustrates an exemplary landlord-tenant approval matrix;

FIG. 6 illustrates an exemplary composite landlord-tenant-property matching matrix;

FIG. 7 illustrates an exemplary process for matching tenants and available properties to generate a pairing list of tenants and properties;

FIG. 8 illustrates an exemplary tenant-property preference list and bids;

FIGS. 9 through 13 illustrate steps for recursively matching registered tenants and available properties based on qualified bids by said registered tenants and their respective tenant-property preference listings;

FIG. 14 illustrates a result of the previous steps, culminating in the allocation of an available rental property to each qualified registered tenant;

FIG. 15 illustrates an exemplary process for matching tenants and available properties to generate a pairing list of tenants and properties;

FIGS. 16-26 illustrate aspects of an overall process for optimizing the matching of available properties and interested tenants in an automated system for carrying out the present process, including

FIG. 16 which depicts an overall architecture of the process;

FIG. 17 which depicts a primary navigation sub-process;

FIG. 18 which depicts a secondary navigation sub-process;

FIG. 19 which depicts management tool operation;

FIG. 20 which depicts a signup sub-process;

FIG. 21 which depicts a searching sub-process;

FIG. 22 which depicts a user dashboard and sub-process;

FIG. 23 which depicts another representation of the user dashboard and sub-process;

FIG. 24 which depicts a property listing sub-process;

FIG. 25 which depicts another aspect of a primary navigation sub-process; and

FIG. 26 which depicts another aspect of the dashboard and sub-process;

FIG. 27 illustrates an exemplary process and architecture for automatic property brokering, information processing and automated contract generation;

FIG. 28 illustrates an exemplary user interface according to an embodiment;

FIG. 29 illustrates an exemplary user interface according to an embodiment;

FIG. 30 illustrates an exemplary user interface according to an embodiment;

FIG. 31 illustrates an exemplary user interface according to an embodiment; and

FIG. 32 illustrates an exemplary process and architecture for automatic property brokering, information processing and automated contract generation.

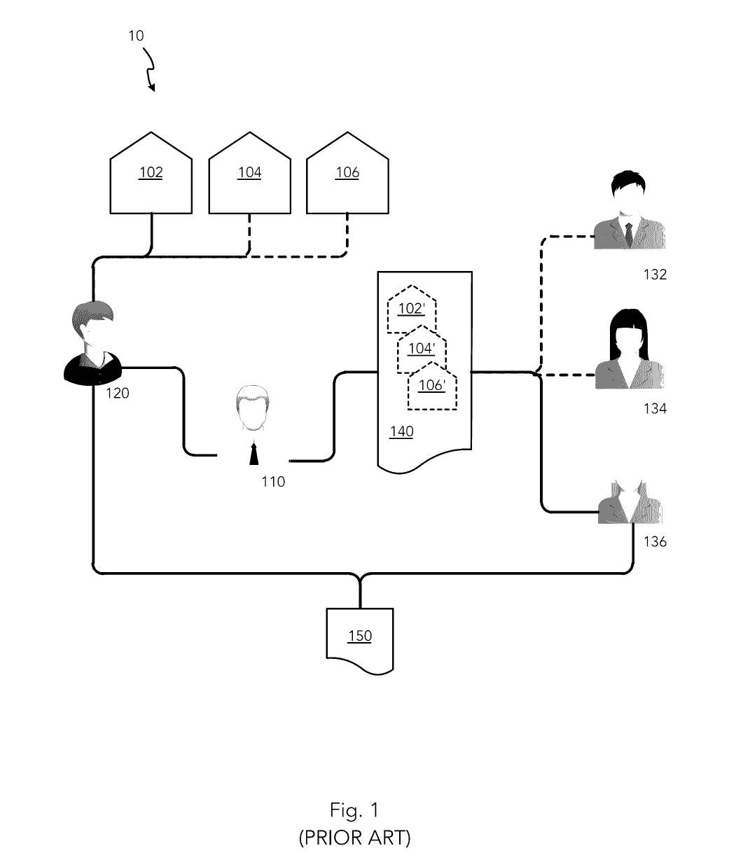

### DETAILED DESCRIPTION

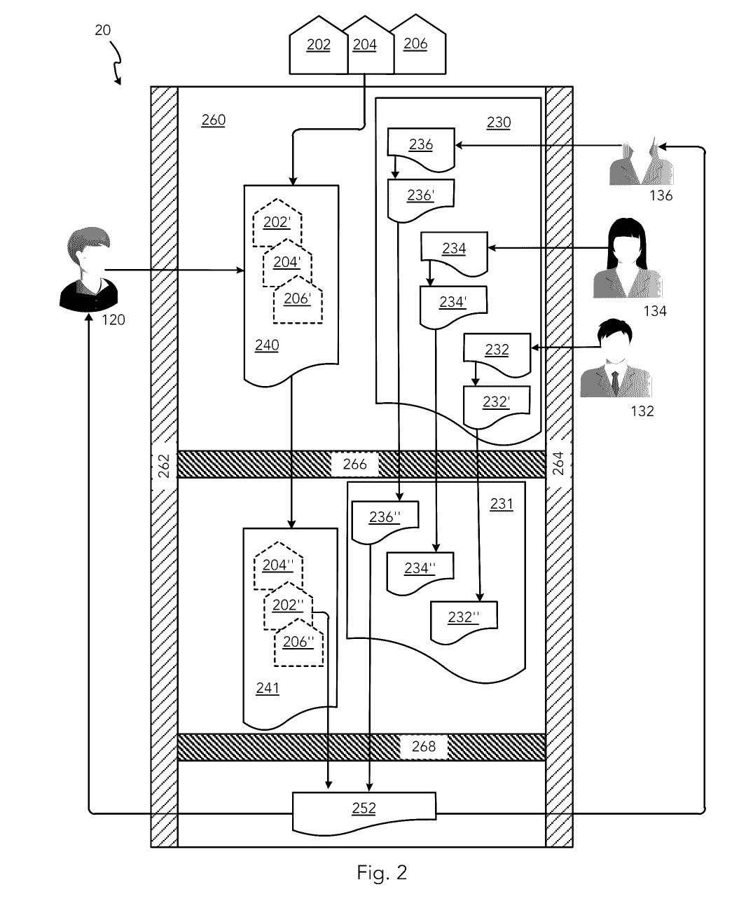

FIG. 2 illustrates one view of an exemplary architecture 20 for a system for allocating landlord-tenant-rental property relationships. A landlord 120 owns one or more properties 202, 204, 206, which are available for rent. One or more prospective renters or tenants 132, 134, 136 seek to rent a property. Therefore, landlord 120, tenants 132, 134, 136 seek to enter into a rental agreement or lease in connection with properties 202, 204, 206. We have discussed conventional print, human and computerized methods for engaging the parties, and a number of drawbacks of conventional methods, above.

A computerized automated system 260 is coupled to a communication network (e.g., the Internet) so as to receive and deliver information and so as to be accessible by entities managing the system 260 as well as entities 120, 132, 134, 136 with a need to use the system. In the present example, properties 202, 204, 206 are depicted or described or represented by rental property information 202′, 204′, 206′, respectively. The rental property information can include basic data about the respective properties such as overall square footage, number of rooms, amenities, location, and so on. The rental property information may also include photographs, videos or other media files representing the described properties. The rental property information is formatted and stored in a listing 240, which may be arranged in a matrix or data structure within a database or data store, in way that is accessible to persons interested in the properties and having access to the rental property information, e.g., over an electronic network connection (Internet, World Wide Web, or other).

Prospective tenants 132, 134, 136 are chosen for their attributes that make them suitable tenants for the available properties 202, 204, 206 and acceptable to landlord 120. The tenant attributes may include a tenant's income and overall and particular financial condition, their lease price ranges, their demographics, their stated interests in properties, pet ownership, length of intended tenancies, and other factors. Each tenant 132, 134, 136 applying for the rental of an available property submits a corresponding application 232, 234, 236 into a tenant data store 230, which can be implemented as an organized database, table, matrix or other information storage unit. The personal and financial details of a tenant's application and other personally identifying information may be encrypted or treated with the appropriate security measures to avoid compromising the tenant or the landlord to liability in the event of the unwanted release of such information. The system 260 formats and conditions the tenant application data into a conditioned or refined or filtered set of applications 232′, 234′, 236′.

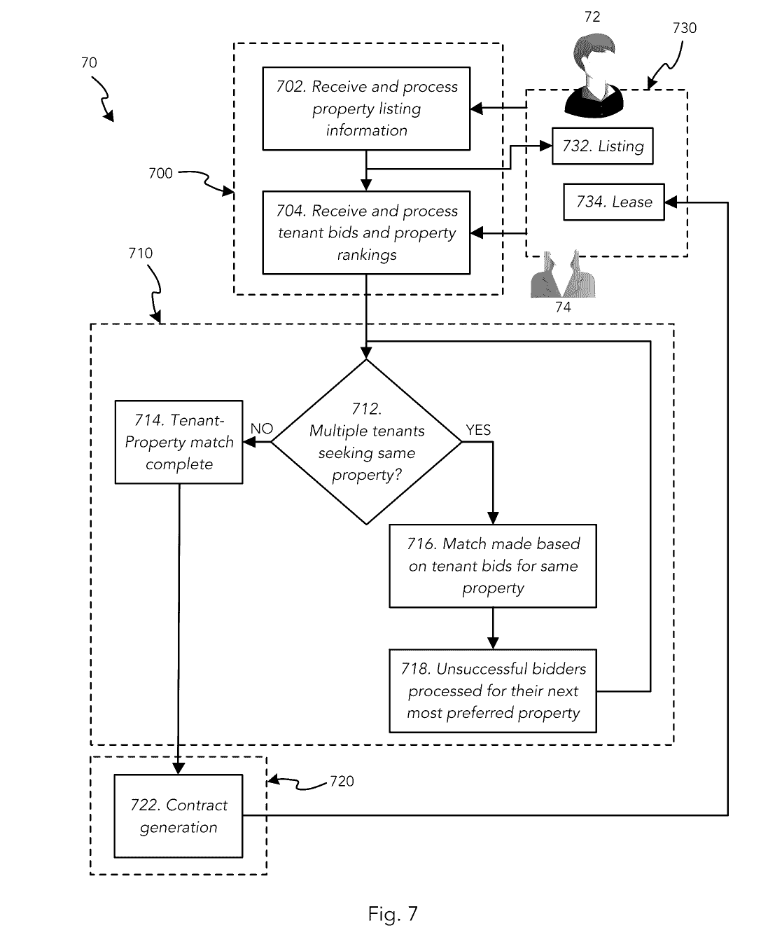

The system 260 includes a matching unit 266 (such as the one shown in FIG. 7) that processes the refined tenant applications 230 and the property listing 240 according to a preferred or optimized ranking and eventual matching that best places the tenants into the most suitable rental properties as will be described in more detail below. The matching unit 266 can yield a sorted listing 241 for each tenant (e.g., 136) that ranks the properties in order of suitability for that tenant, and similarly can yield a sorted listing 231 that both vets and ranks the tenants in order of their suitability for a given property or rental arrangement. For example, vetted and sorted application 236″ may place tenant 136 as the lead tenant candidate for a sorted property represented by 202″ in the sorted listing 241 and determined to be the best match for tenant 136.

In an aspect, system 260 is used to coordinate physical (or virtual) showings of the rental properties 202, 204, 206 at a predetermined time, for example on a Saturday afternoon or on a Sunday morning. Any tenant interested in a given unit (e.g., 202) that has an open house time period can attend this showing during which the landlord or his/her agent will give access to the prospective tenants to inspect the unit and to answer questions about the unit, give out informational materials, etc. No offers will be accepted from prospective tenants during the open house showing times. This way, the tenants are not scrambling or competing to place offers and deposits on rental properties to secure the properties before another tenant does so as happens often with existing methods. The tenants can visit one or more properties during the time periods for showing, then the tenants go into a computer application or app designed for the present purpose, and the tenants can submit their decisions and offers for the units they are interested in. In some embodiments, tenants are given a determined time window within which to decide on and bid on rental properties that they are interested in. For example, tenants may be allowed 24 hours to think about the properties, see other (unrelated) opportunities, consider their financial needs, consult family members, etc.

In an aspect, the tenants 132, 134, 136 indicate in their applications 232, 234, 236 what price range of leases they are seeking or willing to bid on certain properties and other tenant characteristic information, which is used to pre-filter which properties are presented to the tenants at the onset of the process.

In another aspect, the landlord 120 can set a minimum lease price for each unit in the listing 240. This pricing is then negotiable after the open house showing time period. If a unit is highly desirable by many prospective applicant renters, the value of the unit will be accordingly reflected in the bids by the tenants for the lease on the unit.

The system 260 will finally take into consideration all of the economic and other characteristic information from matching unit 266 and use the ranked listing 241 and ranked tenant applications 231 to generate a lease 252 using a lease contract generator 268. The lease contract generator can use existing rules and templates to customize and automatically create a legally-enforceable document (paper or electronic) that must be executed by the landlord 120 and a tenant 136 for the lease of a given rental property 202. Landlords and tenants may be given a limited time window in which to execute lease 252, for example one day or two days.

In an aspect, the open house showings may be conducted on a Saturday and the process (execution of the lease) is completed by Sunday. The applicants for a rental property may be notified of the results of the process using a software program that generates and electronic notification message, and app or similar modality. The non-winning applicants for a rental property may be offered their next-wanted rental unit, and so on. The tenants have a tenant interface 264 into the system 260, and the landlords may have another interface 262 into system 260. However, this is not meant as limiting, and both landlords, tenants, as well as agents of each may use a same interface depending on the desired implementation. The present process is automated and carried out in computing and data processing systems as described herein. A system manager manages the operation, security and polices content of the information and use of system 260. The system manager may charge a fee, which can be much less than a traditional broker's fee, for operating and maintaining the system 260.

In another aspect, the applicant renters and landlords may agree in advance to a leasing arrangement in which the tenants make several bids, one bid for each rental property they are willing to rent. The bids have corresponding prices offered by the tenants, depending on their means and on their interest in the given properties. Specifically, tenant 136 may bid $3,200/month on apartment 202 and also bid $3,000/month on apartment 206. Another applicant tenant 132 may bid $3,000 on apartment 202 and $3,300 on apartment 206. In this case apartment 202 would be awarded to renter 136 and apartment 206 would be awarded to renter 132. It should be understood that the present examples are presented only for the sake of illustration. Many variations and embodiments are possible, which can be chosen based on the desired outcome of the process. As will be seen from the present examples, the process can be optimized in the interest of prospective tenants applying for rental properties, or in the interest of property owning landlords or (conceptually) in the interest of the available properties, which can be seen as seeking renters.

The ranking and bidding by applicant tenants is used by the present process taking place in system 260 between the time that tenants visit the properties and the time that matches and lease contracts are generated. For example, if open house times are on Saturday and the lease generation and execution is set for Sunday. In an example, the ranking and bidding by tenants can take place on Saturday using the user interface and inputs described above. Then, the matching of tenants and rental properties is carried out in automated system 260 on Saturday night by the matching unit 266. The results of the match and associated paperwork (e.g., leases) are sent out to the parties involved following the matching step. Matching unit 266 is programmed, configured and arranged to perform optimizations and may include computer-executable instructions to maximize the overall or specific benefits to landlords and/or tenants by an optimization matching process. As stated, a minimum bid for a given unit may be required, and such minimum floor value could be published in listing 204 or may not be published, depending on implementation.

It will be appreciated that the system 260 can be generalized and scaled to accommodate a plurality of landlords 120, a plurality of geographic locations, many tenants, and many rental properties as needed.

The overall matching process above carried out in matching unit 266 can employ one or more methods and quantitative techniques, including some that are borrowed from or adapted from known matching methods. For example, the Gale-Shapley algorithm is an example of a solution that can be used along with the present system and method for matching landlords, tenants and properties. In some aspects, once the present method is implemented, no two renters would exchange apartments and be happier with the exchange made (at the prices set). Other, possibly related, techniques known or developed for organ donor matching, student-school matching, medical residency matching and so on can be used or adapted for the present application and context.

In another aspect, the system manager can raise extra revenue from operating and maintaining system 260 by placing or pushing targeted advertising content to landlords 120 or tenants 132, 134, 136. Relocation and property service vendors may send special offers to participants in the system 260 in exchange for access to the databases of system 260, or indirectly through the system manager. In still another aspect, the parties participating may contractually allow selected use of their information, for example anonymized data, for the purposes of improving the design and operation of the system 260 or for commercial benefit of the system manager.

In yet another aspect, a service which may be the same as the system manager service, can act to collect rent payments. In an example, if rent is paid on a credit card, credit card rewards on rent payments may be awarded.

Other aspects allow for optional landlord improvement input from system 260. For example, a more realistic or economically efficient base lease price can be determined by system 260 based on the amount of interest and bids being made on a given unit (upward or downward from the landlord's original expected price). This assists in efficient price setting for rental properties.

Other examples and embodiments include an automated or human-assisted process for generating the rental property information listing 240. Photography, video, floor plans and other multimedia data can be collected by the same entity or a vendor of the system 260 manager/operator. Still other embodiments may additionally include automated or human-assisted background checking, credit checking or reference checking as part of vetting renter applicants and ranking the prospective tenants.

In another embodiment, the landlord interface 262 manages communication of updates regarding a listed unit to its owner landlord 120. A computer program, email message, or app alert signals to landlord 120's computer or mobile communication device that an offer has been made, vetted and is recommended by system 260. Landlord 120 can then confirm his or her approval of the renting of the given unit to the given applicant simply and for example by clicking and “Approve” or similar button on the provided application. System 260 may be designed and configured to operate with a general interface, e.g., World Wide Web (browser) interface, or may be further programmed to operate with a specially made application or app installed in the computing device (e.g., personal computer, tablet, smart phone) of landlord 120 and/or tenants 132, 134, 136.

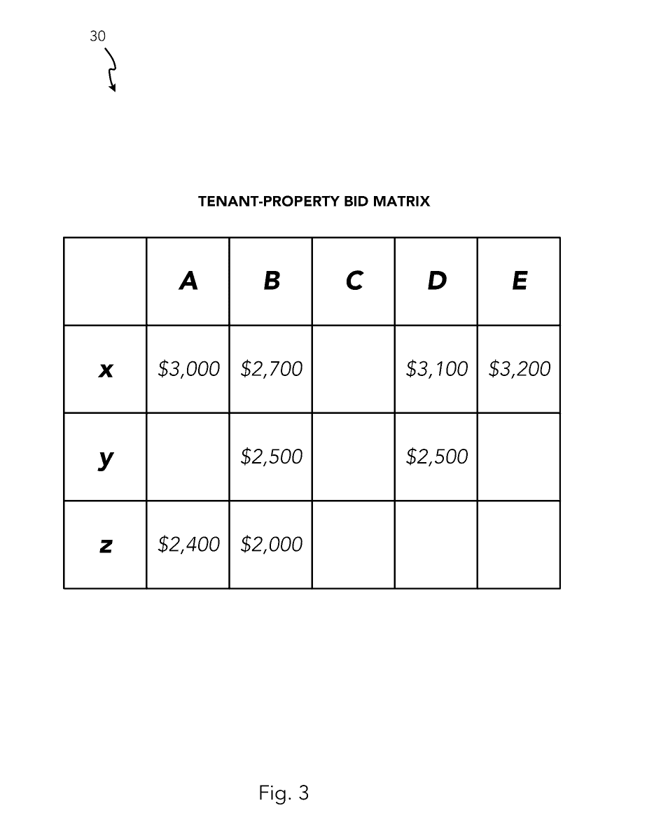

FIG. 3 illustrates an exemplary tenant-property bid matrix 30. This is a representation of a group of potential tenants (A, B, C, D and E) and some available rental properties (x, y and z). Tenants A through E visit one or more of units x through z on the allotted open house time windows. The entries in matrix 30 represent monthly lease price bids by prospective tenants for available rental properties. Here, renter A bid $3,000/month for a lease on property x and that same renter A also bid $2,400/month for a lease on property z. This does not mean that renter A wants to or will lease both properties x and z. It means that renter A is legally willing to enter a lease on either of these properties at the stated bid price. Similarly, renter B is willing to rent any of properties x, y or z at the bid prices. Renter C did not bid in time for any of the properties. Renter D would pay $3,100/month to rent property x or $2,500/month for property y. Renter E only bid on property x in the amount of $3,200.

The tenant-property bid matrix 30 is entered into system 260 and matching unit 266 so as to optimally match renters, landlords and rental properties as described herein.

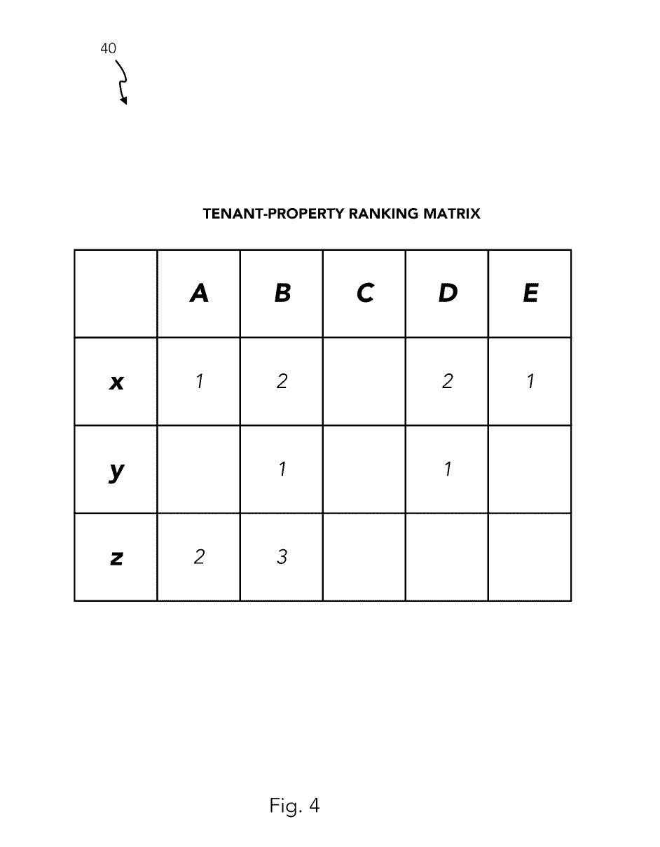

FIG. 4 illustrates a tenant-property ranking matrix 40, which holds data indicative of tenant ranking or preference for the available rental properties. Renter A indicated that her first choice “1” is for property x and her second choice “2” is for property z. She is not interested in property y. The other renters indicate similar preferences for properties x, y, z as shown. This information is also available to system 260 and matching unit 266 for determination of the best result in leasing the properties to the renters.

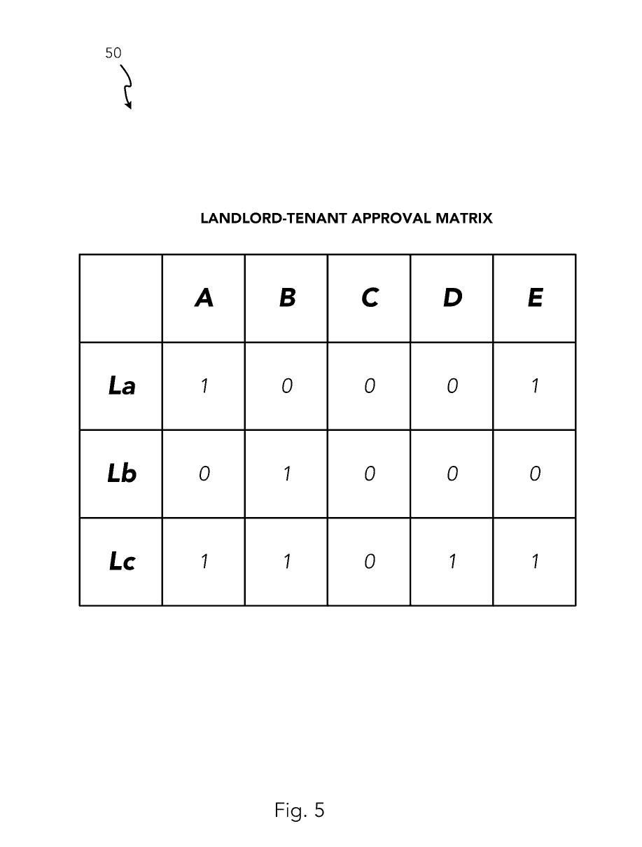

FIG. 5 illustrates an exemplary landlord-tenant approval matrix 50. This matrix represents (in a binary fashion) whether a given renter (A, B, C, D, E) is approved by or acceptable to a given landlord (La, Lb, Lc). So for example, Landlord La approves to rent to tenants A and E but not to tenants B, C, D. Landlord Lb will accept tenant B but none of the other tenant applicants. Landlord Lc agrees to rent to any tenant in the group except for tenant C. This approval process can be indicated on the landlord 120's user interface in some embodiments as described earlier. Also, a human or machine broker can be employed to make such determinations.

In yet other embodiments, the landlord or landlords can rank and rate the applications from the prospective tenants. So instead of the binary matrix above, the landlords' preferences can be in ratings (zero to ten, one to five stars, on a percentile scale, and so on). The system 260 and matching unit 266 can take in the landlord-tenant approval matrix data in determining the best matches for leasing the available properties.

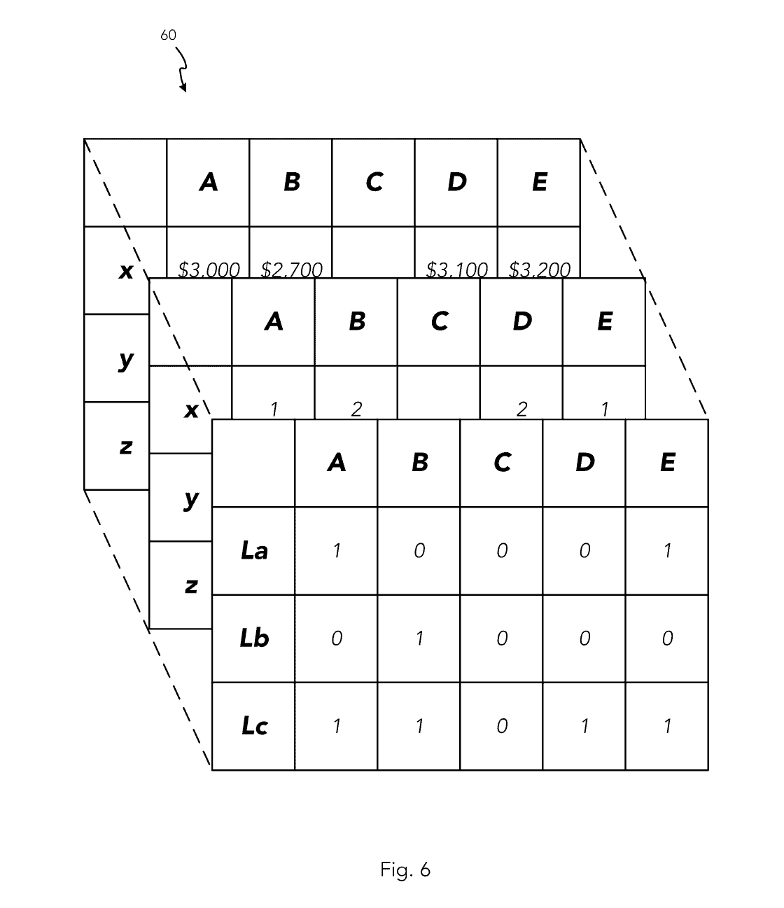

FIG. 6 illustrates a composite landlord-tenant-property matching matrix, data structure or data store 60 comprising a multi-dimensional set of information representing tenant, rental property and landlord needs and preferences. System 260 and matching unit 266 can take such a matrix 60 and use it in determining the final allocation and best matches between available rental units, landlords and tenants in a multi unit, landlord and applicant tenant scenario. Those skilled in the art will understand that the present examples and discussion can be generalized quantitatively and qualitatively. Other factors can be added along the lines discussed above. Geographic location indexing, walkability indexing, crime rates by zip code, address, and many other factors can be added to the tables and matrices given herein by way of illustration. Also, weighting factors can be introduced and biased in favor of an economically desired overall outcome. For example, one landlord may be mostly interested in the price he or she can obtain for a property, while another landlord may have a strong interest in the background of his or her tenant, and these factors may be custom weighted in a matching unit 266 accordingly (to give but one example).

FIG. 7 illustrates an exemplary architecture 70 for optimized landlord-tenant-property matching, information processing and automated contract generation. The architecture or system 70 comprises a user interface component 730, a data processing component 700, a matching component 710 and a contract generation component 720. These components may be implemented as specialized hardware units within an overall processor-based machine, or they may be implemented as separate pieces of equipment including processing hardware, data storage hardware, communication hardware, and document delivery or printing hardware. Each of said pieces may further include electronic circuits for handling, receiving and sending, storing, and executing machine readable instructions or programming steps.

Use interface 730 can be used by a landlord 71 and/or tenants 74 to exchange information with the rest of the system 70. For example, landlord 72 can input information regarding one or more properties and tenants 74 can enter information about themselves and what they are looking for. Then, tenant 74 can see processed and sorted listings 732 and other membership or subscription information. The landlord and tenant members of the system can also receive a lease 734 when it is generated.

Data processing component 700 processes, sorts and formats information. For example, it receives and processes property listing information from landlord 72, putting this information into a form suitable for uniform listing to tenants and agents using user interface 730. Data processing component 700 can prepare sorted listings for matching component 710 that matches the best pairs of tenants and available rental properties as described earlier with respect to matching unit 266.

The matching component 710 of system 70 automatically, in a processor executing machine readable instructions, determines if multiple tenants are seeking to rent a same property at step 712. If each prospective tenant is interested in a different rental unit then the tenant—property match is easily completed at step 714 by assigning or pairing the tenants and desired properties to one another. But if multiple prospective tenants rank a same property as their desired rental, and in essence are competing for the same property, then a match is made based (at least in part) on the tenant rental price bids for the property at step 716. A successful bidder (tenant) 74 may be the tenant offering the highest rent amount for the desired property. Other factors including tenant profile information may also be used to weigh in favor of the winning tenant for the property.

The unsuccessful tenants who also wanted the same property will be processed at step 718 with regard to their next most highly rated or ranked properties (e.g., their second favorites, third favorites, and so on) recursively until all tenants have been matched to a rental property. In an aspect, by bidding on and indicating an interest in a property, a tenant is agreeing to rent the property, even if it is not his or her favorite choice. The system can accordingly attempt to assign tenants their preferred rental properties, but a recursive automatic matching routine such as that illustrated may lead to various outcomes that are globally beneficial to the group of tenants and landlords participating in the process.

The system generates a lease 734 in contract generation step 722 in a document generation engine or component 720. Template and modular clauses may be used to automatically populate a legal document such as a lease using the landlord, property and tenant information and other information that is merged into the final document. The lease 734 is presented, e.g., electronically or by email or hard copy to the parties 72, 74 needing to execute the lease document. In the end, if more qualified bids are presented by more registered tenants than available units, the most competitive bidders will be assigned to their indicated available properties according to their bids and other factors considered by the matching unit 266. If more available properties exist than registered tenants bidding for the same, and the bidding tenants indicate an interest in a plurality of such properties, the matching process will be able to pair each qualified bidder with an available property of interest. In a preferred embodiment, the final contracts (leases) are generated only after all tenants and rental properties are paired by the matching unit 266 and no property is still available and still has multiple tenants seeking to rent it. However, one of skill in the art would understand to implement the invention as needed for a given application and the present preferred steps or order of steps could be manipulated to suit other examples as well.

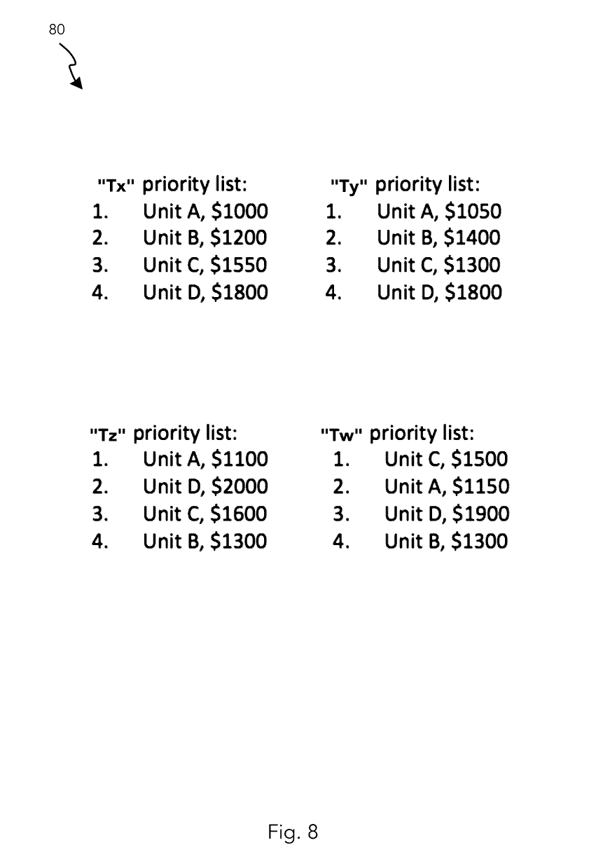

FIG. 8 illustrates exemplary ranked or prioritized ordering 80 of rental properties (A, B, C, D) that are under consideration by four prospective tenants (Tx, Ty, Tz, Tw), along with the lease price bids (e.g., monthly rent) each is willing to pay for the respective property.

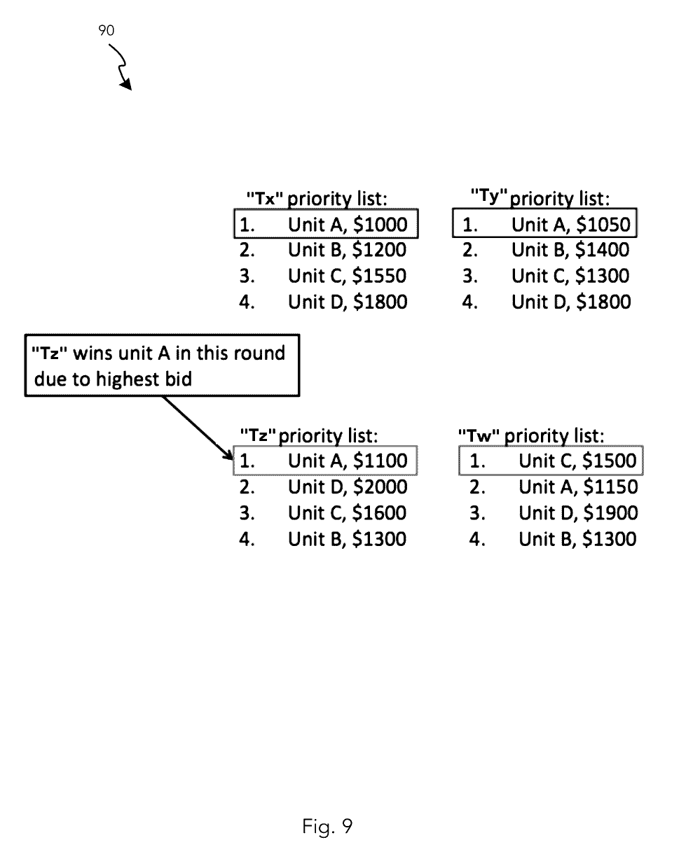

FIG. 9 highlights at 90 the top-ranked property of each tenant. We can see that Tx, Ty and Tz all rate Unit A as their preferred property to rent. Therefore, matching engine 710 must carry out the process for determining which renter will be leasing which Unit. In the present example, rental properties are awarded to tenants based on a recursive consideration of the tenant bids on the rental price for the properties. Therefore, the system resolves competition among multiple tenants for a same unit. We see that Tz will be tentatively awarded the lease on Unit A because Tz bid the highest price for the unit among the three tenants bidding for Unit A who all consider Unit A to be their most desired choice.

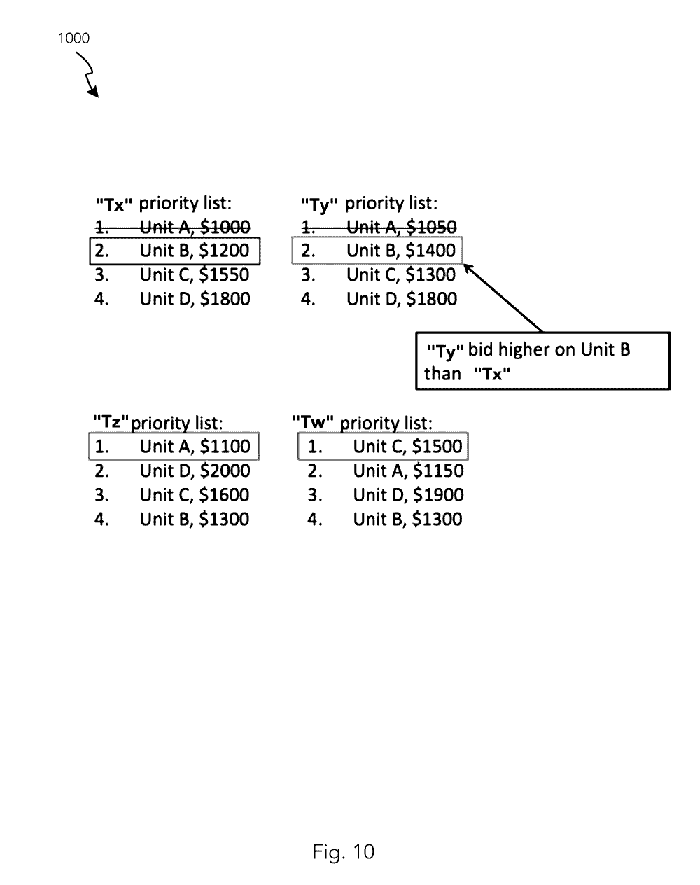

FIG. 10 illustrates at 1000 how Tx and Ty are out of consideration for Unit A because their bids for it were unsuccessful. Tx and Ty both indicated Unit B as their second choice however, and will compete for Unit B in matching engine 710. Ty being the higher bidder for Unit B with no other competitors at this stage bidding for Unit B, Ty is awarded the lease for Unit B.

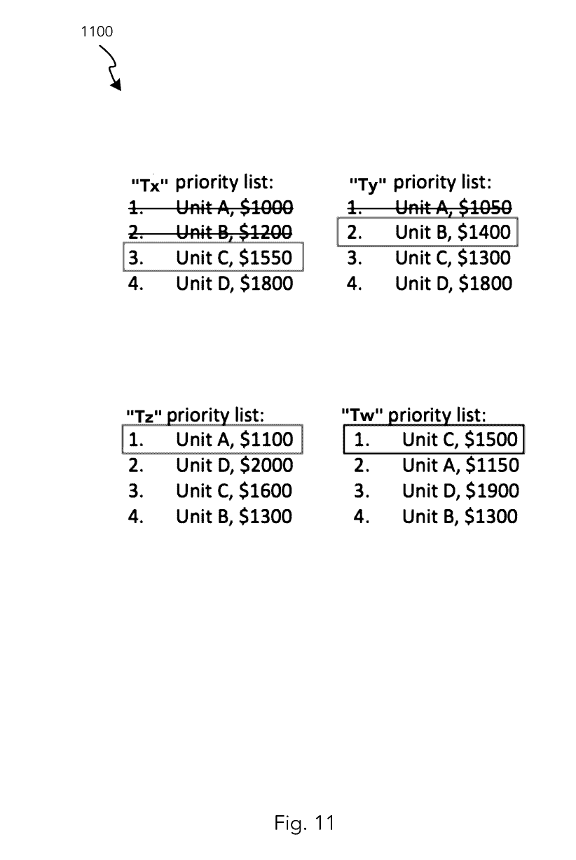

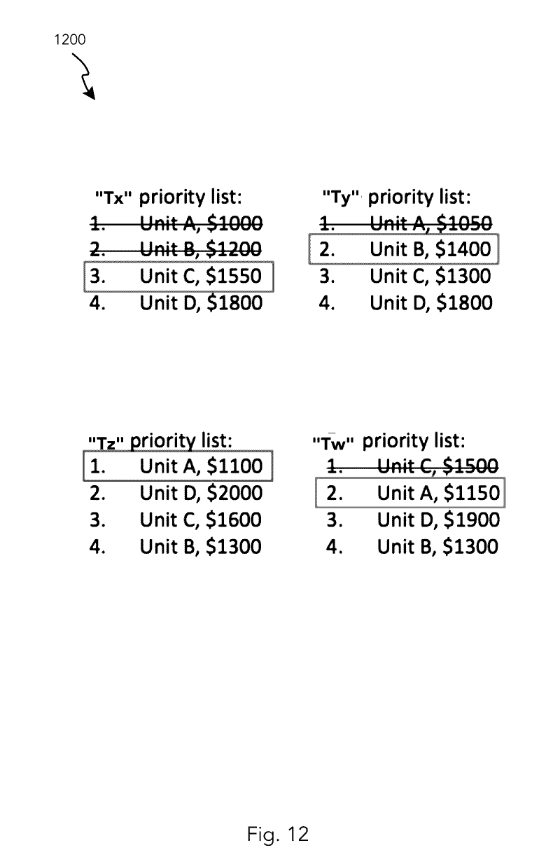

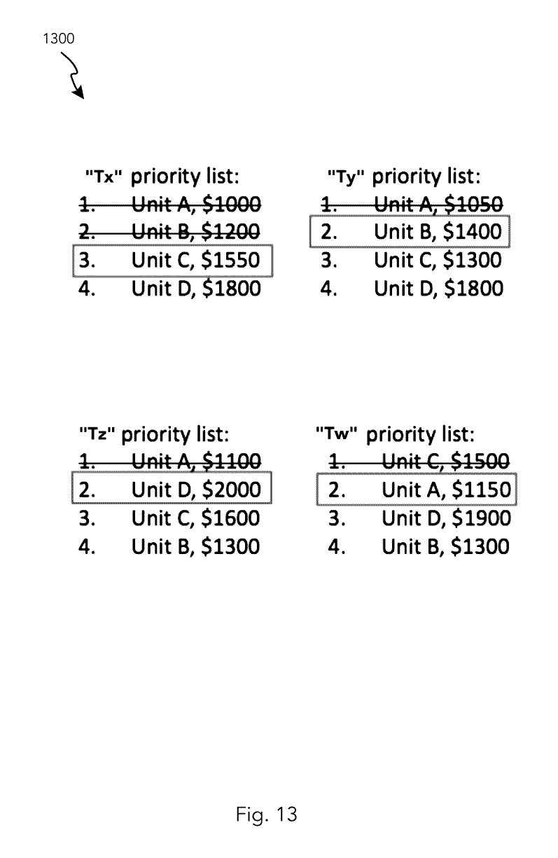

FIG. 11 illustrates at 1100 that Tx has been unsuccessful in obtaining a lease on Unit A or Unit B will place Tx in competition for Unit C, his third choice. Here, Tx and Tw will compete for Tx's third choice and Tw's first choice, Unit C, which will go to Tx as he bid $1,550 compared to Tw's losing $1,500 bid for Unit C. Tw must therefore be put into a match on her next most desired units in FIG. 12. Tw and Tz compete for Unit A at 1200. FIG. 13 illustrates that Tw beat out Tz for Unit A by outbidding him. Tz is therefore not eligible for his first choice Unit A.

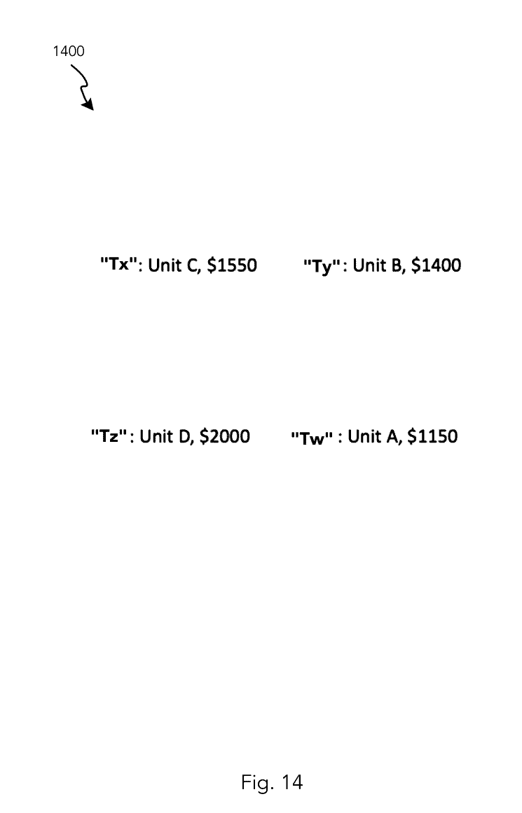

FIG. 14 illustrates the final outcome of the matching process above. Since there are no remaining competitions among the tenants for the available units, and each unit has been optimally matched to the renter offering the best price for it, the contracts for the rental leases may be finalized. Here Tx will rent Unit C for $1,550, Ty will take Unit B for $1,400, Tz takes Unit D for $2,000 and Tw rents Unit A for $1,150. This is one method for matching the renters and the available units that maximizes the economic outcome in an economically stable and efficient sense. Those skilled in the art will appreciate that other methods for matching the tenants and the properties are also possible. For example, the bid prices may be but one factor in a multi-factor equation deciding among tenant bids. Specifically, in an instance, the bid price is taken into consideration along with credit score, or other tenant profile information. Therefore, if two persons ranked and bid a given property equally the system can take into account a secondary factor to decide among the bidding tenants.

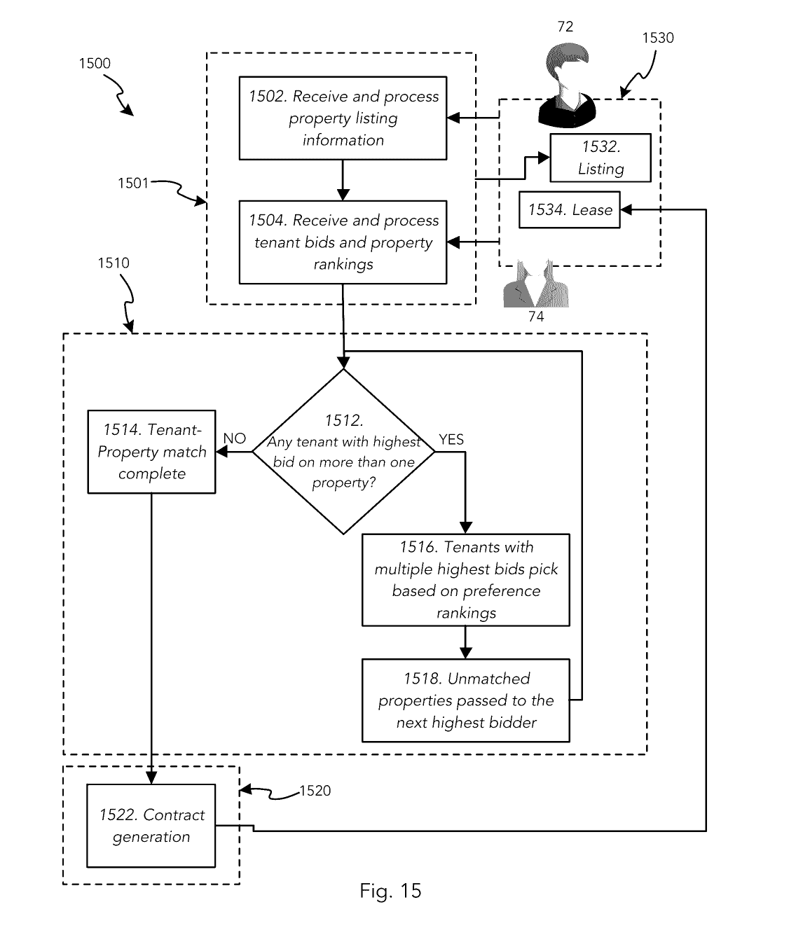

FIG. 15 illustrates another embodiment of a process 1500 automatically carried out in the present system, which can be compared to FIG. 7 above.

FIG. 15 addresses the situation where multiple available properties have a same given highest bidder. As stated, the present matching unit and method would not allocate more than one available property to a same candidate tenant because a tenant only needs one property to rent. Here, the matching system determines at 1512 whether the situation has arisen where a same tenant was the highest bidder on more than one available property. If so, the tenant having made highest bids on two or more properties is paired to a property based on his/her stated preference ranking in said properties. At 1518 any unmatched properties are passed on to the next highest bidders for the properties. The exemplary embodiment of FIG. 15 will resolve and optimize the pool of tenants and rental properties, leading to the unique best pairing according to a given implementation, and leading to the generation of legal documents (leases) after all of the tenants and properties have been allocated.

As can be seen, the system can optimize the allocation and pairing of tenants and available properties. However, those skilled in the art will appreciate that a relative or local or subjective optimization is possible, and that other implementations or algorithms for matching can result in other self-defined most optimum outcomes. In any case, the system operates as programmed and configured using the hardware and software employed. In an aspect, a stable set of pairings associating available rental properties and interested applicant tenants is generated.

It should be noted that the present recursive methods can involve multiple steps in the recursion, or in some embodiments the process needs to only pass once through the recursive process. The recursion therefore signifies one or more passes through the depicted process.

So a method according to the present disclosure may involve multi-stage processing of data including in a processing and formatting engine; a matching stage performed in a matching engine and an automated document generation engine that in the end creates contracts or leases for landlords and tenants according to the results of a matching process, which in turn acts on processed and refined tenant and property information in a processing stage.

The present discussion and illustrative examples show several features of the present inventions. In some aspects, the present process and system allow for one-to-one matching or pairing of available rental properties and prospective bidding tenants applying to lease the properties. The present system and process ensure an orderly assignment of tenants to desired properties, taking into account the tenants' stated preference rankings for the properties, the tenants' monetary bids for the properties and other factors. Here, a prospective tenant seeking a rental property can submit multiple legally-binding bids for multiple properties, but unlike in a conventional auction, the tenant will not be legally bound to take all of the properties he or she submitted bids on. The tenant's bids will be input to and automatically processed as described so that the tenant may be entitled to and obligated to lease only one of the properties desired (if any).

Consider a tenant who is interested in several available properties. It is possible hereunder that this tenant is the highest bidder on multiple such properties. In a traditional auction process, the tenant would be required to take all of the properties that he or she was the highest bidder on. For this reason, under traditional auction arrangements, bidders must be careful to only bid on their most desired property, then wait to discover the results of that auction, before making bids on another property to avoid being held to two or more leases simultaneously. In doing so, bidders in conventional systems may miss out on their alternative desired properties because they had to wait for the results of their first bid before daring to bid on another property. Conventional systems and processes are therefore serial in nature. Here, however, the tenant bidding for one or more desired properties may be assigned to lease only one of said desired properties, and will not be forced to take all of the properties indicated in his or her bids. This is to say that the present system and method, through its automated processing and data handling as described, can handle batch processing of multiple bids, multiple bidders and multiple properties being bid on, without causing undesired outcomes. Any property that a bidder has bid on, given to the bidder, would be acceptable to (and binding on) the bidder.

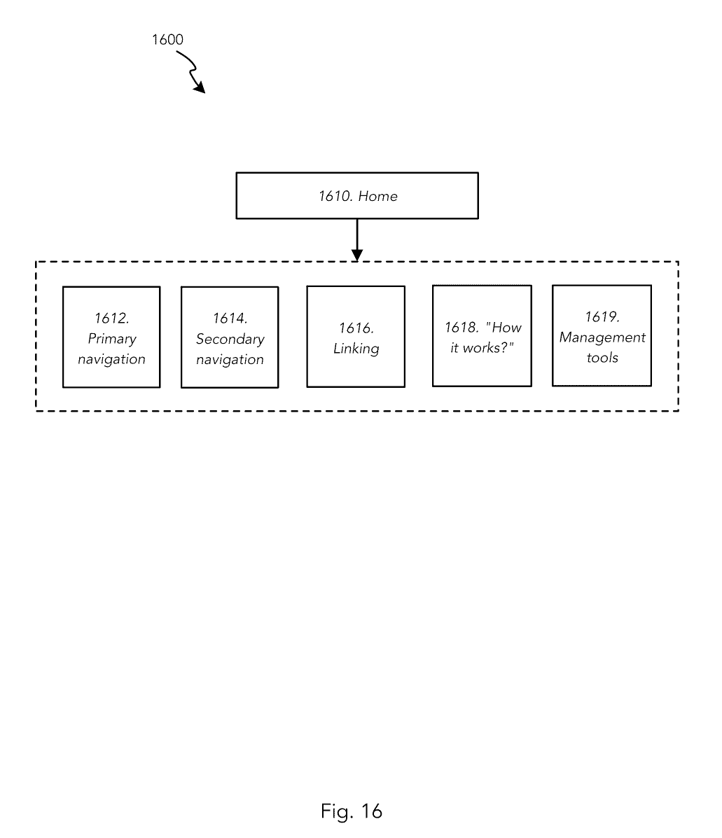

FIG. 16 illustrates an exemplary process and architecture 1600, which may be implemented in an automated machine such as a computer processing system as described above. The various steps and modules described below are implemented in a system interconnecting them where they appear in the following figures as separate drawings for convenience. Those skilled in the art will appreciate that the following drawings are able of being carried out all together in a system and process, which is evident through the common naming and numbering of the enumerated steps and modules below.

A Home state 1610 or Home reference module of software and/or hardware is coupled to or leads to several main steps or architectural modules or states. These include Primary Navigation 1612, Secondary Navigation 1614, “How It Works?” 1618, and Management Tools 1619, which are explained in more detail below.

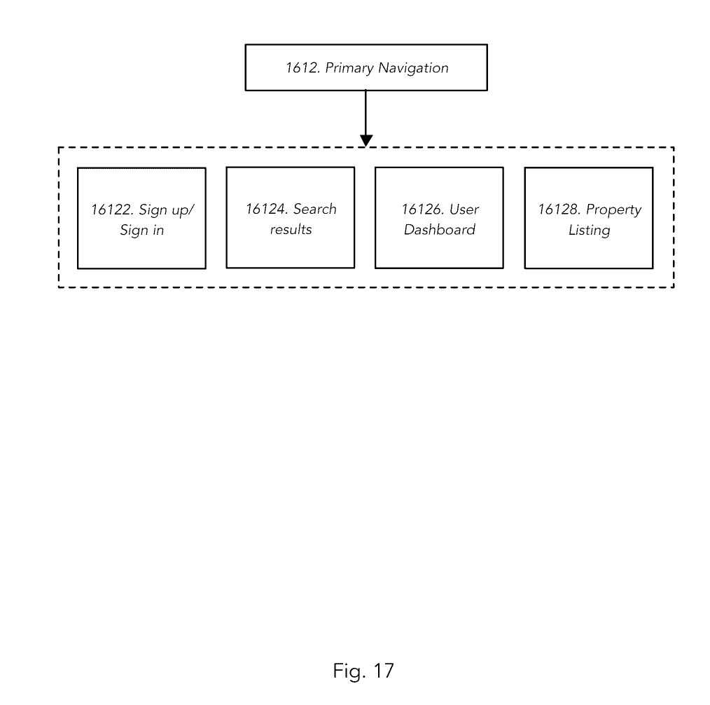

FIG. 17 illustrates an exemplary set of methods or groups of steps and modules of the present system that can be carried out under the Primary Navigation 1612 step in an embodiment hereof. The Primary Navigation 1612 step can include a variety of user interface and interactivity modules and methods thereunder such as Sign Up/Sign In 16122, Searching 16124, User Dashboard 16126 and Property Listing 16128.

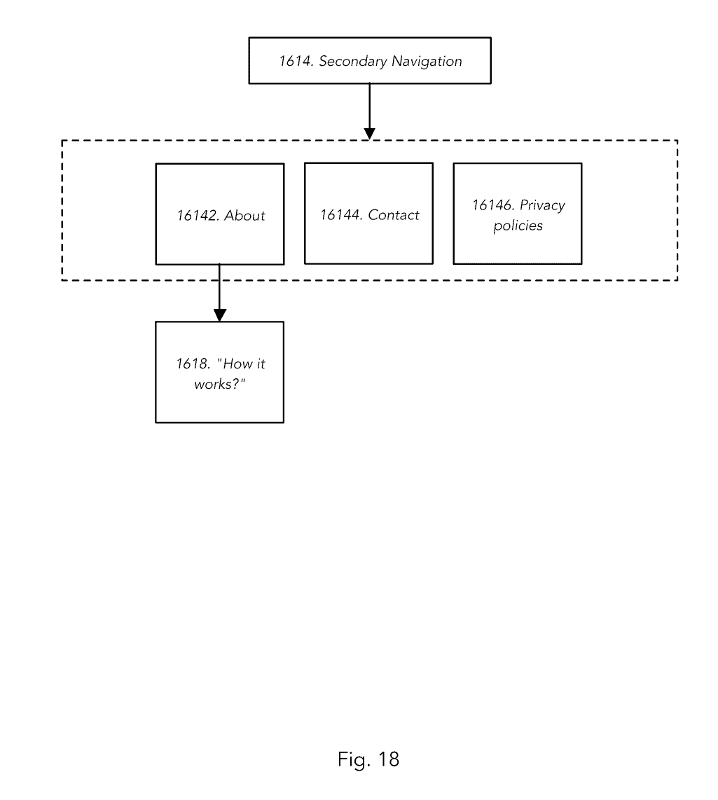

FIG. 18 illustrates an exemplary set of methods or groups of steps and modules of the present system that can be carried out under the Secondary Navigation 1614 step in an embodiment hereof. The Secondary Navigation 1614 can include various About 16142, Contact 16144, Privacy 16146 and other instructional or informative steps thereunder.

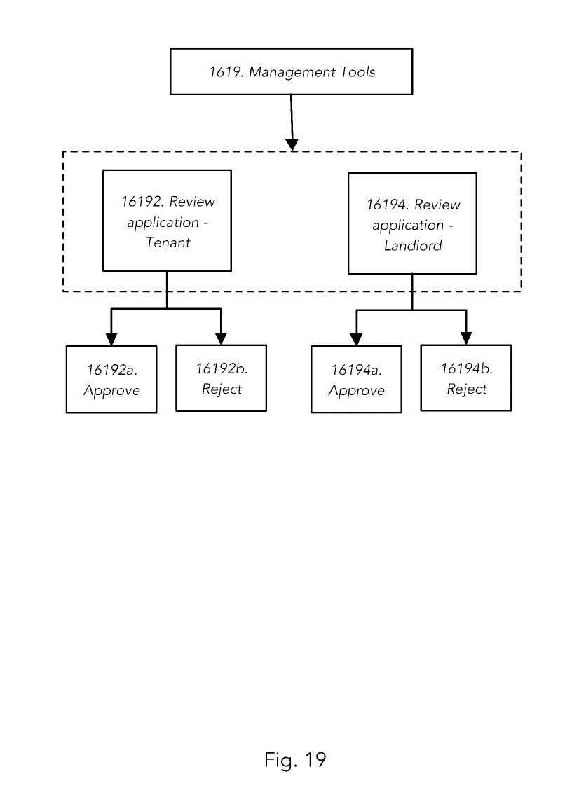

FIG. 19 illustrates exemplary account and system management tools 1619, which permit review of applications from the tenant side 16192 or the landlord side 16194. Each party is allowed to approve or reject an application as shown.

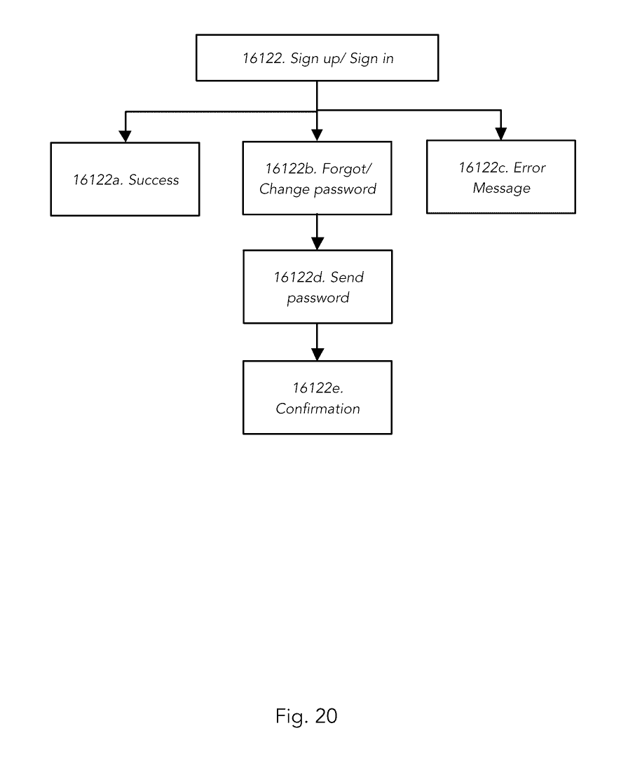

FIG. 20 illustrates the Sign up/Sign In process 16122 in an exemplary aspect. Passwords are managed under this step or group of steps.

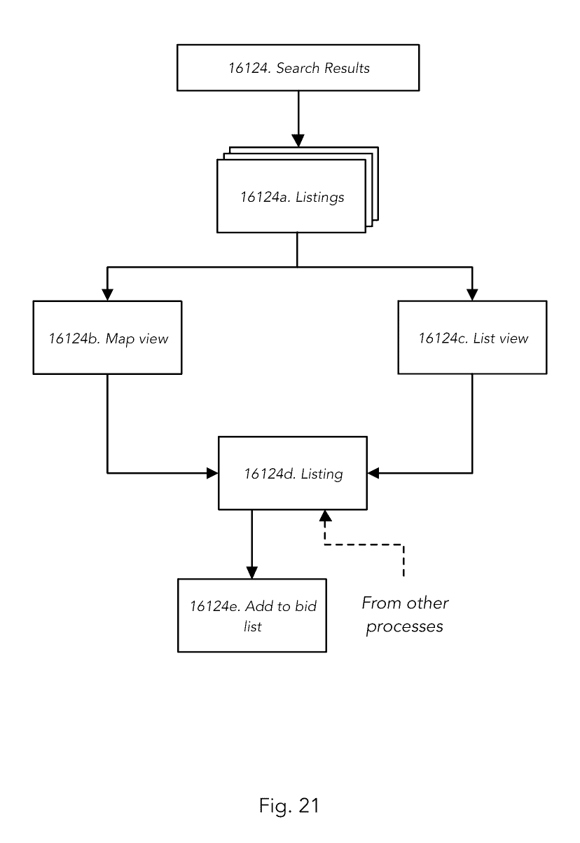

FIG. 21 illustrates an exemplary searching scheme according to an aspect of the illustrated embodiment. Search results 16124 may present users with a plurality of listings at 16124a. Map view 16124b and list view 16124c are available in an example. A listing 16124d may be generated and added to a bid list at 16124e.

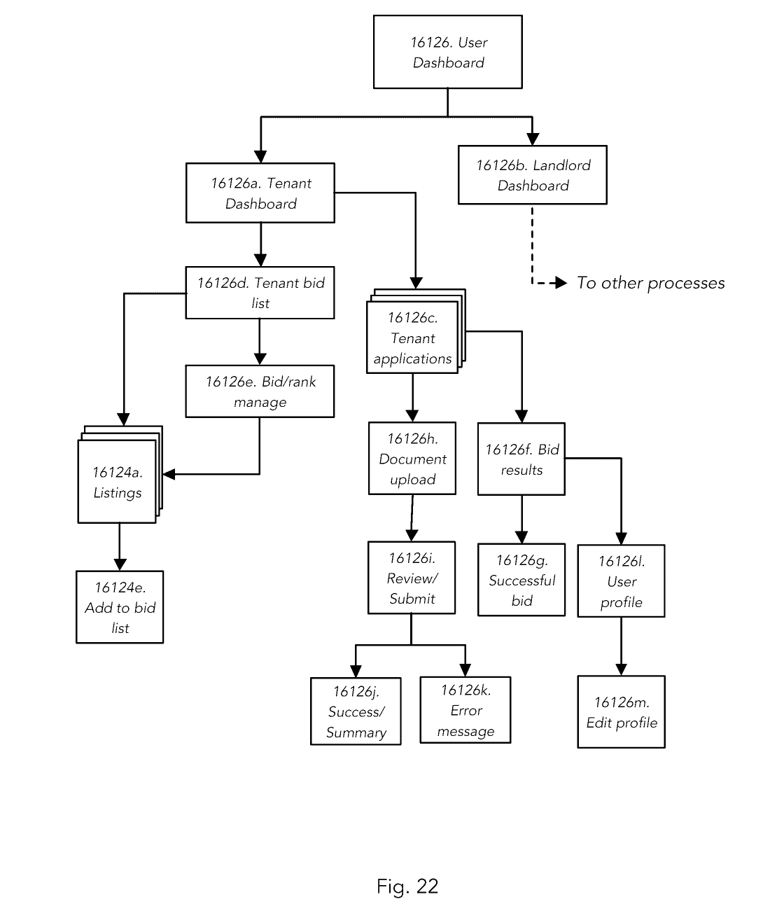

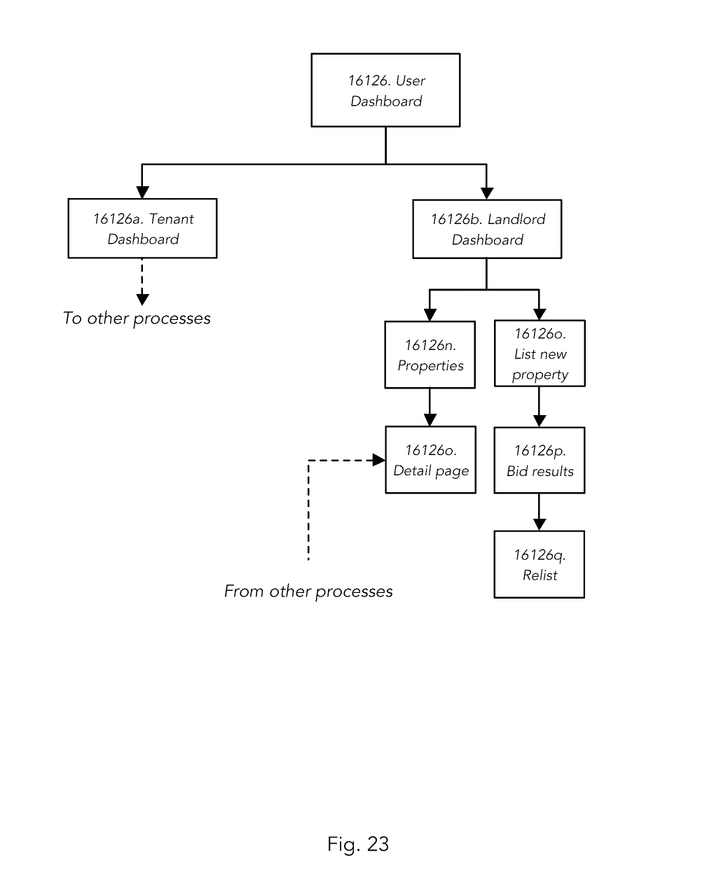

FIGS. 22 and 23 illustrate exemplary arrangements of modules or steps in a process under the Dashboard 16126 described above. The tenant dashboard 16126a and landlord dashboard 16126b can be presented to registered tenants and landlords, respectively. Applications are processed (e.g., tenant applications at 16126b) and bids are handled according to the bid/rank process 16126e described earlier.

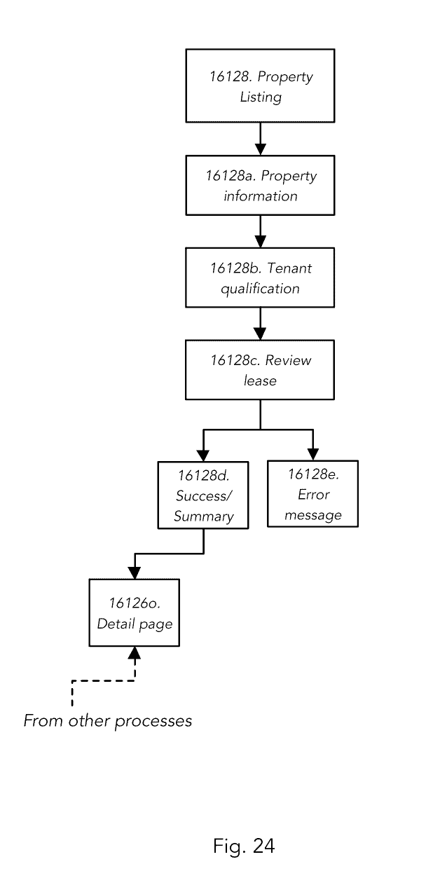

FIG. 24 illustrates the process for handling property listings 16128 according to an exemplary embodiment. The process includes procedures for entry and review of property information 16128a, tenant qualification information 16128b, review of proposed lease 16128c, and other indications of success or failure of the process. A detailed page 16126o is generated for review at the end of the process.

Those skilled in the art will appreciate that many other implementations of a process map may be carried out according to this invention similar to or equivalent to the examples provided above. The flowcharts of FIGS. 16-24 in particular lend themselves to other equivalent and similar implementations in that the order of the steps and the combination or splitting of steps into further sub-steps can be achieved without loss of generality. The ordering of the steps can also be accomplished according to the desired implementer's needs without departing from the present invention as a whole.

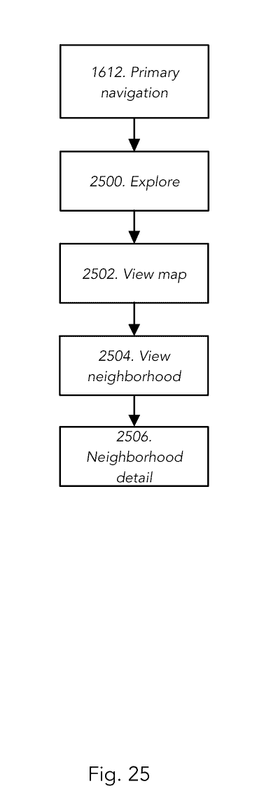

FIG. 25 illustrates another feature of some exemplary embodiments of the invention. Here, the primary navigation step 1612 can include an optional exploration step 2500, which permits viewing of a map. For example, a user interface equipped with a graphical display unit will display an image of a selected geographic region (by area, address, etc.) at step 2502. The user can then navigate, zoom or manipulate the map at step 2504 to view a neighborhood of interest within the map (e.g., a neighborhood including the address of a rental property). The user interface can also provide detailed information about the neighborhood of interest to the user at step 2506.

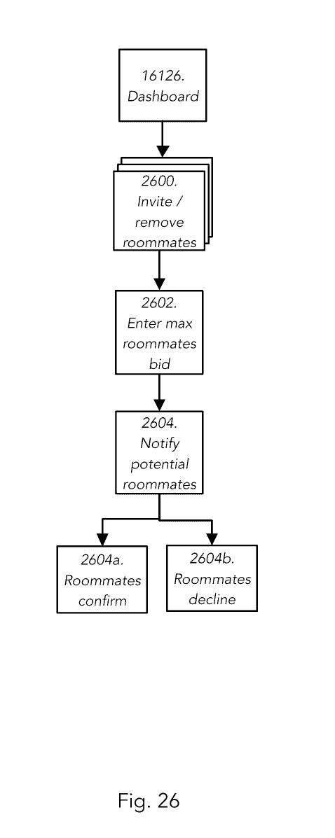

FIG. 26 illustrates another exemplary feature of embodiments of the invention whereby a renter can seek or collaborate with potential roommates interested in a property (i.e., to cohabitate in the property with the bidding tenant). From the Dashboard 16126 a user can invite and/or remove roommate candidates at step 2600. The system can enter a maximum roommates bid at step 2602, which indicates the maximum bid put in by a group of tenants who plan to rent a unit together and who will jointly agree to a bid price (rent amount). Potential roommates are notified at step 2604, which can be by electronic mail (email) or by another suitable communication means (e.g., telephone, fax, push message, SMS message, or others). The potential roommates who receive the invitation may then accept/confirm their interest at 2604a or decline the invitation at 2604b.

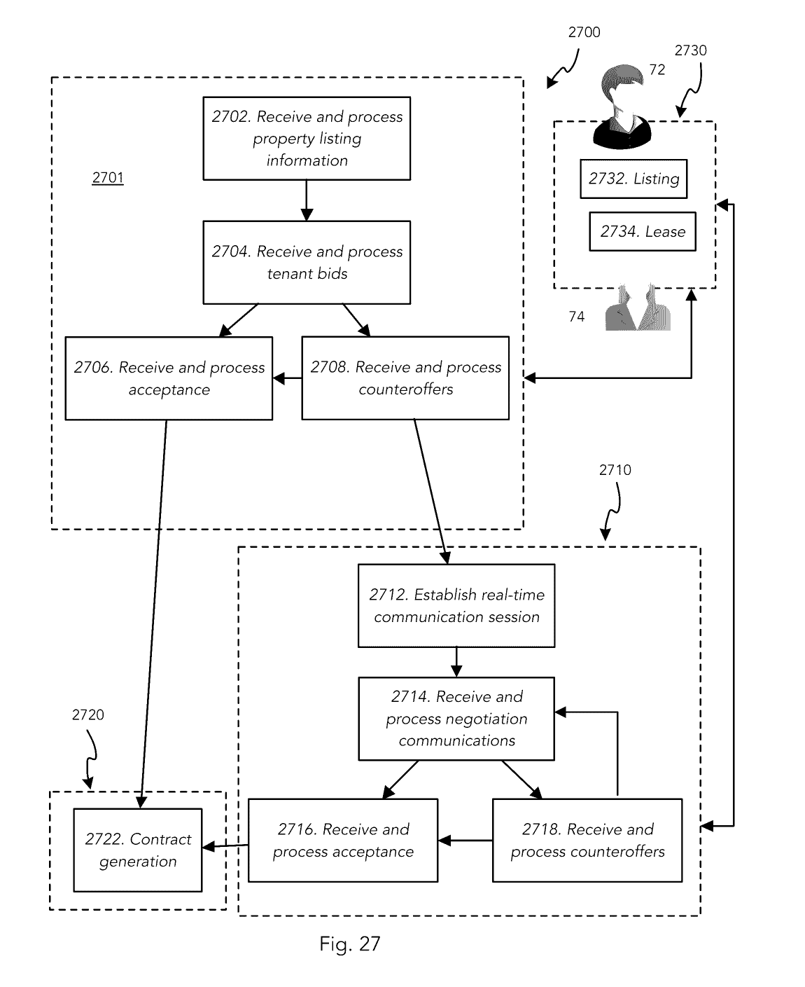

FIG. 27 illustrates an exemplary architecture and method 2700 for automatic property brokering, information processing and automated contract generation. The architecture or system 2700 comprises a user interface component 2730, a data processing component 2701, a real-time communication component 2710 and a contract generation component 2720. These components may be implemented as specialized hardware units within an overall processor-based machine, or they may be implemented as separate pieces of equipment including processing hardware, data storage hardware, communication hardware, and document delivery or printing hardware. Each of said pieces may further include electronic circuits for handling, receiving and sending, storing, and executing machine readable instructions or programming steps.

The user interface 2730 can be used by a landlord 72 and/or tenants 74 to exchange information with the rest of the system 2700, similar to the embodiments described above. For example, landlord 72 can input information regarding one or more properties and tenants 74 can enter information about themselves (e.g., through a common application) and what they are looking for. Then, tenant 74 can see processed and sorted listings 2732 and other membership or subscription information. The landlord 72 and tenant 74 members of the system can also receive a lease 2734 when it is generated. In some embodiments, tenant 74 can include one or more roommates, who must each register with the system 2700. One tenant 74 can invite a roommate through the user interface 2730, for example by entering the roommate's email address.

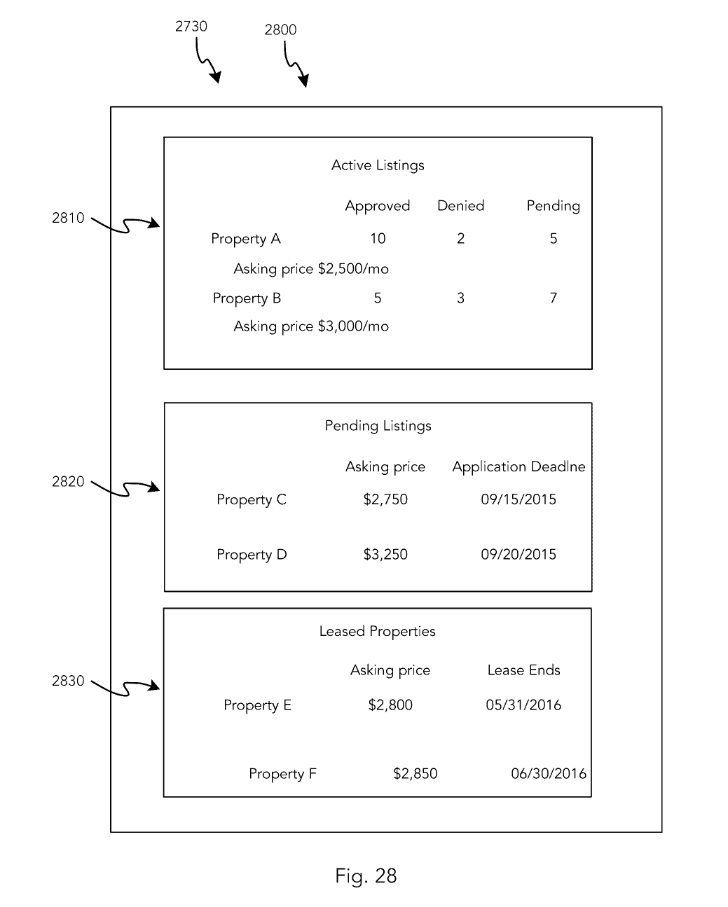

In some embodiments, the user interface 2730 can provide the landlord 72 and/or tenant 74 with a dashboard. For example, as illustrated in FIG. 28, a first dashboard 2800, for the landlord 72 can include a list of the rental properties that the landlord has registered with the system 2700 including their rental status. In some embodiments, the first dashboard 2800 for the landlord 72 can include active listings 2810 (accepting applications and/or undergoing bidding), pending listings 2820 (advertised for accepting applications in the future), and leased properties 2830. The active listings section 2810 can include, for each active property, the asking/guide price, the number of applications approved, the number of applications denied, and the number of applications awaiting approval. The pending listings section 2820 can include, for each pending property, the asking/guide price and the deadline for submitting applications. The leased properties section 2830 can include the monthly rent and the lease termination date. The first dashboard 2800 can be updated in real time.

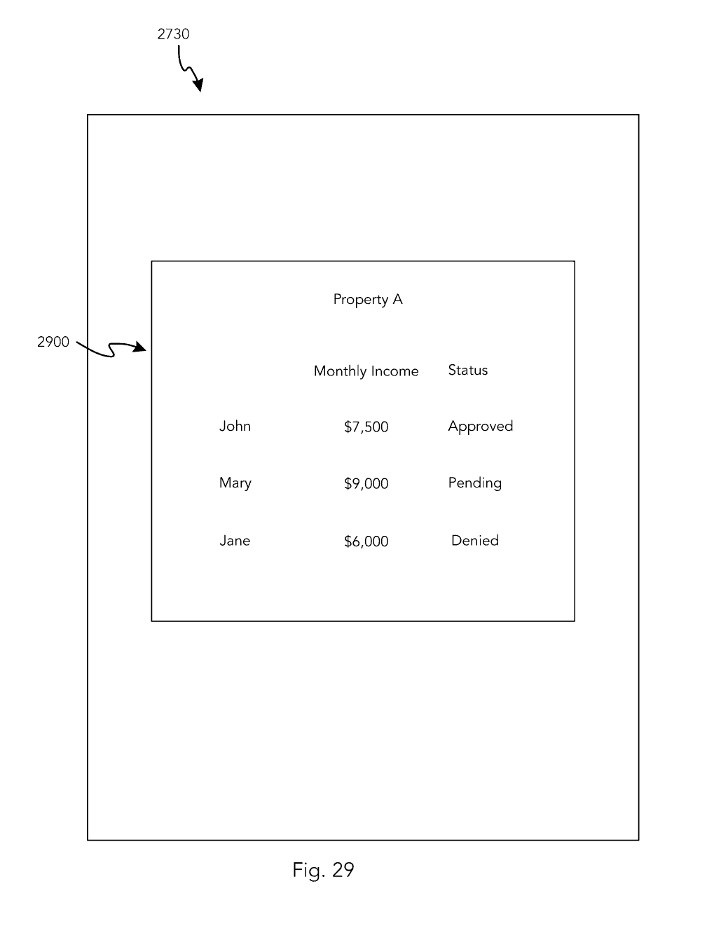

In some embodiments, the user interface 2730 can provide the landlord 72 with a second dashboard 2900 of applications for a given active listing, as illustrated in FIG. 29. The second dashboard 2900 can include the applicant's name, relevant financial information for the applicant (e.g., monthly income), and the applicant's status (e.g., approved, awaiting approval). If an applicant is awaiting approval, the landlord 74 can view the details of the applicant's application, the applicant's credit report, and the applicant's background check (e.g., criminal and/or credit checks). The credit report checking process can involve a number of processes and checks relating to the applicant's personal and financial history, public and private data, etc. The applicant's application can include personal information, residence history, employment history, references, and screening questions. In some embodiments, an applicant fills out an application or a common application when he establishes an account with the system 2700. The system 2700 can verify the applicant's application and can check the applicant's credit and criminal history before the applicant can inquire about an available property listing. Using the second dashboard 2900, the landlord can approve or reject a given application. For example, the landlord may reject an application that states that the applicant has a pet or that states that the applicant that has a low credit score. The second dashboard 2900 can be updated in real time.

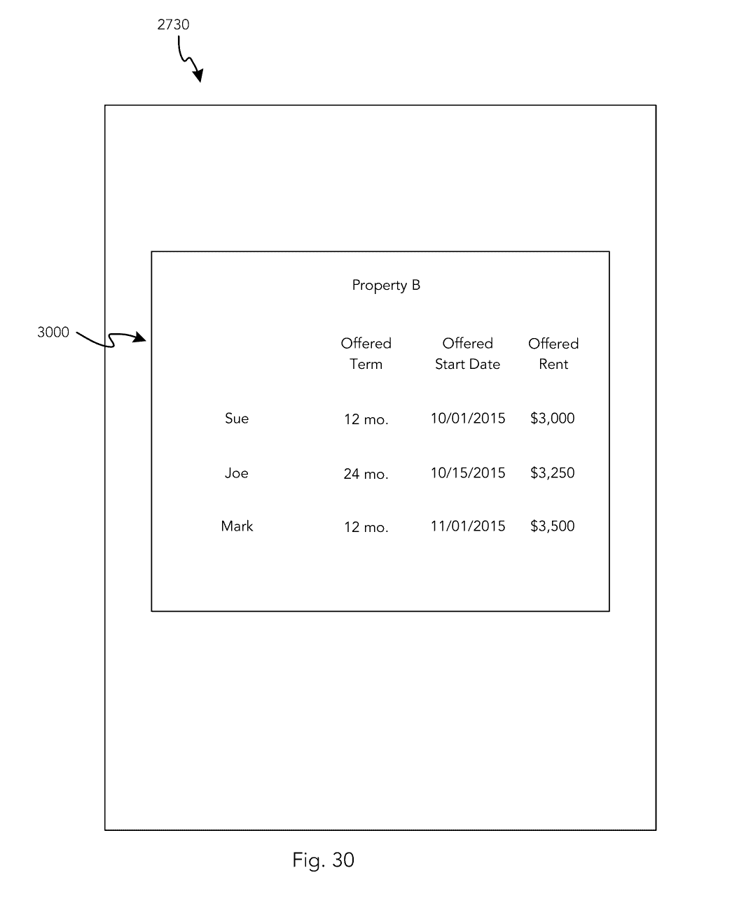

The user interface 2730 can also provide the landlord 72 with an offer dashboard 3000 for a given property undergoing bidding, as illustrated in FIG. 30. The offer dashboard 3000 can include the identity of each applicant, the offered lease term, the offered lease start date, and the offered monthly rent, but may include other information as well. The landlord 72 can make a counteroffer to any of these offers through the user interface 2730, as described below. The dashboard 3000 can be configured so that an applicant either can see or cannot see the offers made by other applicants to a property on which the applicant has made an offer. In some embodiments, an applicant cannot make an offer before his application is approved by the landlord (e.g., through second dashboard 2900). The offer dashboard 3000 can be updated in real time.

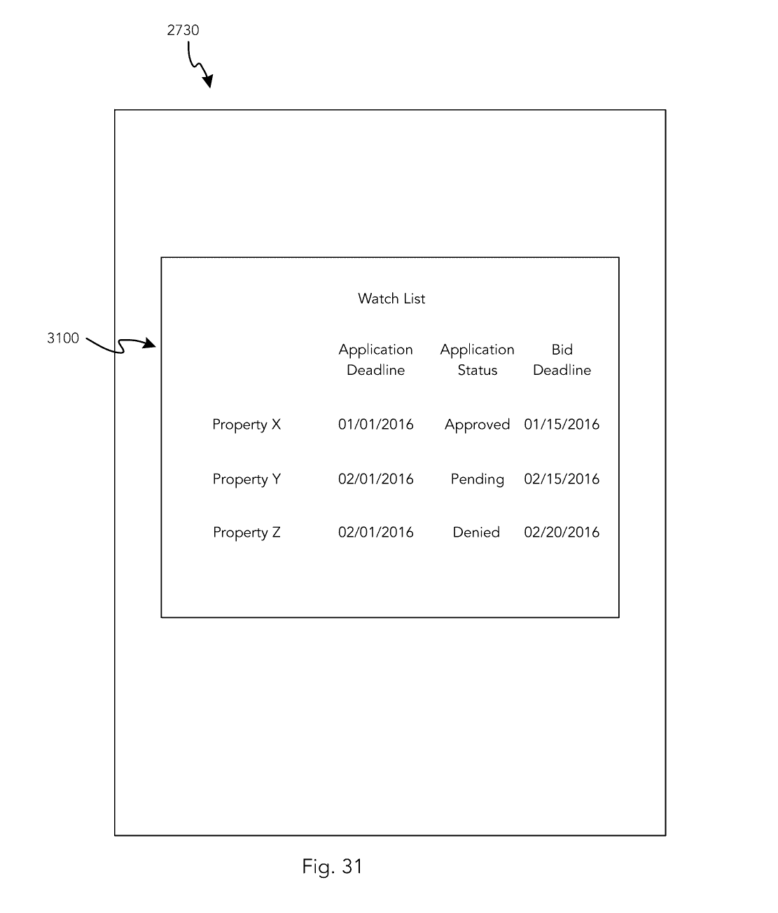

In addition, the user interface 2730 can provide the tenant 74 with a dashboard 3100 of properties of interest, as illustrated in FIG. 31. For example, the tenant 74 can add properties to a watch list for convenience or future reference such as to monitor the application and/or offer deadlines for those properties. The dashboard can also provide a status of the tenant's 74 application for a given property, such as whether the landlord 72 has approved the tenant 74 to visit and place an offer on the property. The dashboard 3100 can be updated in real time.

Returning to FIG. 27, data processing component 2701 processes, sorts and formats information. For example, data processing component 2701 receives and processes property listing information 2702 from landlord 72, putting this information into a common form suitable for uniform listing to tenants and agents for display on user interface 2730. The property listing information 2702 can include a guide rental price set by the landlord 72. The guide rental price can indicate the rent that the landlord 72 desires and/or thinks is appropriate for a given property. In some embodiments, the tenant 74 can make an offer below the guide rental price. Data processing component 2701 also receives and processes tenant offers 2704 from tenants 74 for one or more listed properties. Tenant offers 2704 can be 2706 accepted by landlord 72 (in which case a binding contract is formed) or 2708 counteroffered by landlord 72. The counteroffer 2708 can be 2706 accepted by tenant 74 (in which case a binding contract is formed). Alternatively, the landlord 72 and/or tenant 74 can request a real-time communication session with one another to negotiate one or more components of the offer. The tenant 72 and the landlord 74 can withdraw their offer or counteroffer at any time before it is accepted by the other party.

The real-time communications component 2710 establishes a real-time communications session upon request by the landlord 72 or tenant 74. Although FIG. 27 illustrates that a real-time communications session is established after the landlord 72 conveys a counteroffer, it is noted that in some embodiments the landlord 72 or the tenant 74 can request a real-time communication session before the landlord 72 makes a counteroffer. During the real-time communication session, the parties can negotiate at least one of the rental price, the rental start date, and the lease duration. Such negotiation communications are 2714 processed by the real-time communications component 2710 and provided to the landlord 72 and tenant 72 through user interface 2730. The negotiations can result in 2718 a tenant making a counteroffer to the landlord's counteroffer, which can result in additional negotiations 2714. Alternatively, the negotiations can result 2716 in an agreement by the parties on the terms of the rental, in which case the tenant 72 accepts the landlord's counteroffer. In some embodiments, the landlord 72 cannot make a counteroffer on the rental price if the tenant's current offer or bid is greater than or equal to the guide rental price.

In another aspect, and optionally, applicant tenants' offers or bids can expire after a pre-determined length of time. For example, an offer or bid by a tenant applicant can be automatically void or cancelled or withdrawn (expires) 48 hours from the time it was made. Of course, other expiration durations are also possible.

The system generates a lease 2734 in contract generation step 2722 in a document generation engine or component 2720. The lease 2734 is generated when the last offer (or counteroffer) is accepted, such as in 2706 and 2716.

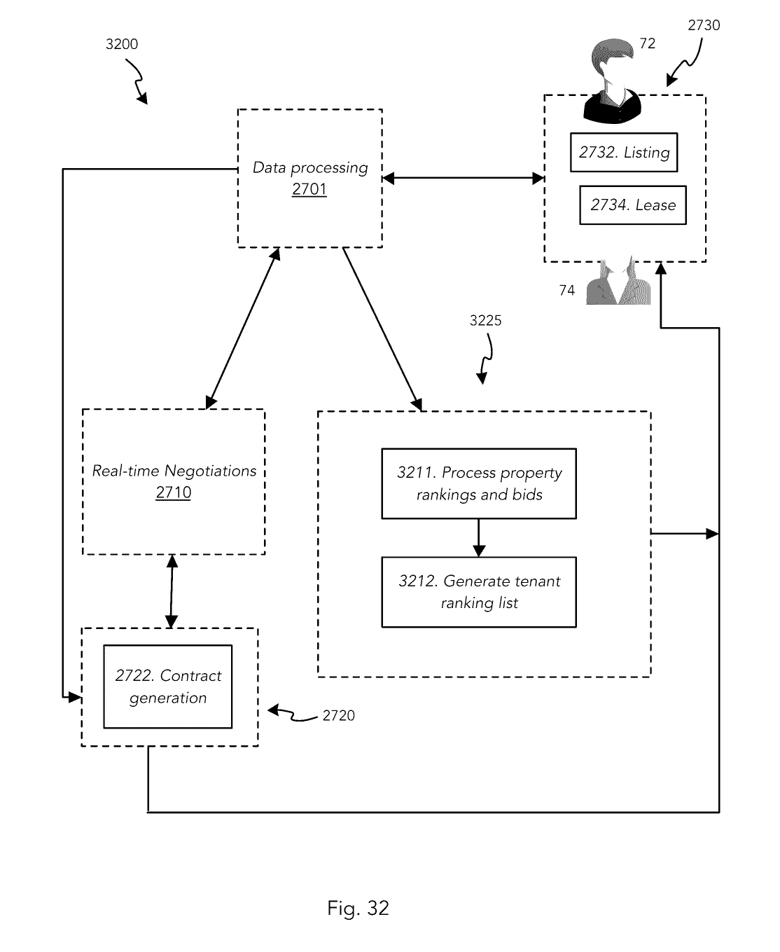

FIG. 32 illustrates an exemplary architecture 3200 for automatic property brokering, information processing and automated contract generation according to another embodiment. In the architecture 3200, a ranking module 3225 is included in addition to components 2701, 2710, 2720, and 2730 described above with respect to FIG. 27. The ranking module 3225 receives data from data processing module 2701. The data includes the tenants' bids and their preference for each property on which they bid, as discussed above. The data can also include other information about the tenants, such as their income, the income-to-bid rent ratio, their credit scores, etc. The ranking module 3225 processes the data at 3211 in a manner similar to the matching module described herein. After processing the data, the ranking module 3225 generates a tenant ranking list 3212, which is provided to the landlord 72 through user interface 2730. The tenant ranking list 3212 can be based on one or more components of data received from data processing module 2701, such as the product of the tenants' preference and bids for each property on which the tenant submitted a bid. The ranking list 3212 generates a logical ordering of the tenants based on one or more data components selected by the landlord 72. In some embodiments, the most competitive bidders are ranked the highest while in other embodiments additional factors are considered as described herein. For example, the tenant with the most competitive bid may have a low credit score in which case the ranking list can lower that tenant's rank. The ranking list 3212 can be generated using a process similar to the matching module described herein, but without automatically allocating a property to a tenant. Instead, the landlord 72 can use the ranking list 3212 as part of her decision on which tenant receives the lease.

Those skilled in the art will appreciate that many other implementations of a process map may be carried out according to this invention similar to or equivalent to the examples provided above. The flowcharts of FIGS. 27 and 28 in particular lend themselves to other equivalent and similar implementations in that the order of the steps and the combination or splitting of steps into further sub-steps can be achieved without loss of generality. The ordering of the steps can also be accomplished according to the desired implementer's needs without departing from the present invention as a whole. In addition, the flowcharts and modules in FIGS. 27 and 28 can be combined with any of the flowcharts and modules described above. For example, the matching functionality described above can be modified so that the server provides a recommendation or an ordered list of recommendations instead of an automatic match. In a particular example, the process (e.g., 1512, 1514, 1516, and 1518) of matching a tenant who has the highest bid on multiple properties can be modified so that the server provides a recommendation to the landlord of each property as to the best tenant for each respective property, such as based on the tenants' preference rankings and bid amounts.

The present invention is not intended to limit the abilities of the participants in the rental unit marketplace. Therefore, the disclosure should not limit those skilled in the art from other implementations or enhancements consistent with the present exemplary embodiments. For example, in an embodiment, the system may permit a first-come-first-served procedure for awarding an available apartment to a meritorious tenant interested in the apartment prior to the foregoing matching process taking place.

Again, the inventors do not presume to enumerate each and every possible configuration for carrying out the claimed invention. But the examples described in the present disclosure and accompanying drawings will clearly convey to those skilled in the art the nature of the invention and numerous preferred methods and configurations for its execution.

As would now be appreciated, the above process removes the chaos and anxiety of first-come-first-served searches for rental properties because all qualified applicant renters are given a fair opportunity to see the available properties available to them. Also, the applicant tenants can then decide the fair market price for a lease for a given unit, which may be guided by a minimum price set by the owner of the unit or by lower or higher offers from applicants indicating the market demand. Also, the present method and system allows for a uniform, high quality, vetted and refined application process so that all landlords and tenants submit and see a unified application and property listing set of documents. The applicants may be personally anonymized as well to avoid intentional or unintentional filtering of tenant applicants by improper criteria such as race, orientation, physical appearance and such subjective (and usually unlawful) factors.

The present invention should not be considered limited to the particular embodiments described above, but rather should be understood to cover all aspects of the invention as fairly set out in the present claims. Various modifications, equivalent processes, as well as numerous structures to which the present invention may be applicable, will be readily apparent to those skilled in the art to which the present invention is directed upon review of the present disclosure. The claims are intended to cover such modifications.

What is claimed is:

1. A method for automatically brokering available rental properties to tenant applicants applying to lease said properties, comprising:
receiving landlord information for at least one landlord seeking to rent an available property through a landlord interface of a server, and recording said landlord information in a landlord data matrix in a data store of said server;
in response to a request from a tenant applicant, automatically providing property information to said tenant applicant through a tenant applicant interface of said server, said property information including data representing an available property to be rented, said property information formatted into a common listing format;
through said tenant applicant interface of said server, receiving a tenant applicant offer from said tenant applicant, said tenant applicant offer including an offer rental price, an offer rental start date, and an offer lease duration and recording said tenant applicant offer in a tenant data matrix in said data store of said server;
automatically transmitting said tenant applicant offer to said landlord through said landlord interface of said server;
through said landlord interface of said server, receiving (a) a landlord acceptance of said tenant applicant offer or (b) a landlord counteroffer to said tenant applicant offer, said landlord counteroffer including at least one of a counteroffer rental price, a counteroffer rental start date, and a counteroffer lease duration;
if said server receives said landlord counteroffer from said landlord, automatically transmitting said landlord counteroffer to said tenant applicant through said tenant applicant interface of said server; and
if said server receives said landlord acceptance from said landlord, automatically generating a leasing document and sending said leasing document to said landlord and said tenant applicant through said landlord interface and said tenant applicant interface, respectively.

2. The method of claim 1, further comprising:
receiving a tenant acceptance to said landlord counteroffer through said tenant applicant interface; and
automatically generating said leasing document and sending said leasing document to said landlord and said tenant applicant through said landlord interface and said tenant applicant interface, respectively.

3. The method of claim 1, wherein said landlord counteroffer is transmitted to said tenant applicant in real time.

4. The method of claim 1, further comprising establishing a real-time communication session between said tenant applicant and said landlord if said server receives said landlord counteroffer from said landlord.

5. The method of claim 4, further comprising:
receiving a tenant applicant counteroffer to said landlord counteroffer through said tenant applicant interface; and
automatically transmitting said tenant applicant counteroffer to said landlord through said landlord interface of said server.

6. The method of claim 1, further comprising:
through said tenant applicant interface of said server, receiving a second tenant applicant offer from a second tenant applicant, said second tenant applicant offer including a second offer rental price, a second offer rental start date, and a second offer lease duration and recording said second tenant applicant offer in said tenant data matrix; and
automatically transmitting said second tenant applicant offer to said landlord through said landlord interface of said server.

7. The method of claim 6, further comprising:
through said landlord interface of said server, receiving a second landlord counteroffer to said second tenant applicant bid, said second landlord counteroffer including at least one of a second counteroffer rental price, a second counteroffer rental start date, and a second counteroffer lease duration; and
automatically transmitting said second landlord counteroffer to said second tenant applicant through said tenant applicant interface of said server.

8. The method of claim 7, further comprising establishing a real-time communication session between said second tenant applicant and said landlord.

9. The method of claim 8, further comprising:
receiving a second tenant applicant counteroffer to said second landlord counteroffer through said tenant applicant interface; and
automatically transmitting said second tenant applicant counteroffer to said landlord through said landlord interface.

10. The method of claim 1, further comprising:
through said tenant applicant interface, receiving an offer revocation request from said tenant applicant;
revoking said tenant applicant offer if said offer revocation request is received by said server prior to said landlord acceptance; and
denying said offer revocation request if said offer revocation request is received by said server after said landlord acceptance.

11. The method of claim 1, wherein said server denies said landlord counteroffer if said counteroffer rental price is greater than a guide rental price set by said landlord, said guide rental price included in said property information.

12. The method of claim 1, further comprising:
through said landlord applicant interface, receiving a landlord counteroffer revocation request from said landlord; and
revoking said landlord counteroffer if said landlord counteroffer revocation request is received by said server prior to a tenant acceptance.
denying said landlord counteroffer revocation request if said landlord counteroffer revocation request is received by said server after said tenant acceptance.

13. A method for automatically brokering available rental properties to tenants applying to lease said properties, comprising:
receiving landlord information from a landlord seeking to rent an available property through a landlord interface of a server, and recording said landlord information in a landlord data matrix in a data store of said server;
receiving property information containing data representing at least one available property to be rented and formatting said property information into a common listing format;
receiving tenant applicant information for registered tenant applicants seeking to rent an available property through a tenant applicant interface of said server, including receiving a tenant-property preference list representing an ordered preference ranking of available properties for each registered tenant applicant;
receiving tenant applicant offers on each of a plurality of available properties in said tenant-property preference list, and recording said tenant applicant information and tenant-property preference lists in a tenant applicant data matrix in said data store of said server;
in said server, ranking said registered tenant applicants and said available properties comprising comparing a plurality of qualified offers by a plurality of registered tenant applicants on a same available property and comparing said same available property in respective tenant-property preference lists of said plurality of registered tenant applicants so as to generate a ranked registered tenant applicant list;
sending said ranked registered tenant applicant list to said landlord through said landlord interface of said server;
through said landlord interface of said server, receiving (a) a landlord acceptance of a first qualified offer made by a first registered tenant applicant for said available property, said first registered tenant having a ranking in said ranked registered tenant list or (b) a landlord counteroffer to said first qualified offer, said landlord counteroffer including at least one of a counteroffer rental price, a counteroffer rental start date, and a counteroffer lease duration.

14. The method of claim 13, further comprising:
if said server receives said landlord counteroffer from said landlord, automatically transmitting said landlord counteroffer to said first registered tenant applicant through said tenant applicant interface of said server; and
if said server receives said landlord acceptance from said landlord, automatically generating a leasing document for said available property and automatically sending said leasing document to said landlord and said first registered tenant applicant through said landlord interface and said tenant applicant interface, respectively.

15. The method of claim 13 wherein said landlord counteroffer is transmitted to said first tenant applicant in real time.

16. The method of claim 13, further comprising establishing a real-time communication session between said first tenant applicant and said landlord if said server receives said landlord counteroffer from said landlord.

17. The method of claim 13, wherein said ranking further comprises quantitatively sorting available properties and assigning sorted values thereto corresponding to registered tenant information and according to the properties' potential suitability for a registered tenant.

18. The method of claim 13, wherein said ranking further comprises quantitatively sorting said registered tenant applicants with respect to said available property and assigning sorted values thereto corresponding to said available property information.

19. The method of claim 13, wherein said ranking further comprises procedurally executing a programmed set of instructions so as to generate an optimized ranking list associating each of said available properties with a best suited tenant who had stated an interest in the respective available properties.

20. The method of claim 13, further comprising automatically cancelling said tenant offer at after a predetermined length of time from said offer being made by said tenant if said offer has not been accepted.

21. A system for automatic brokering of properties, comprising:
a server having at least one processing circuit configured and adapted to execute machine readable instructions, a digital data store coupled to said processing circuit configured and adapted to store said machine readable instructions and data for processing in said processing circuit;
a landlord interface, having a first port coupled to said server and a second port coupled to an external communication layer available to said landlords, and further configured using machine readable instructions and executed in said processing circuit, and further configured and adapted to receive landlord information containing data identifying a registered landlord who owns at least one available rental property and for receiving property information containing data representing attributes of said available rental property;
a tenant interface, having a first port coupled to said server and a second port coupled to an external communication layer available to said registered tenant, said tenant interface configured and adapted to receive tenant information containing data identifying a registered tenant who seeks a rental property and for receiving attributes of properties that said registered tenant is seeking;
a communication interface coupling said server to said registered landlord through said landlord interface, and coupling said server to said registered tenant through said tenant interface;
a landlord data matrix comprising digitally stored and formatted landlord information in said digital data store, said landlord information identifying said registered landlord as well as other landlord information corresponding to said registered landlord;
a tenant data matrix comprising digitally stored and formatted tenant information in said digital data store, said tenant information identifying a registered tenant, a tenant-property preference list, offer data containing offers by said tenant for at least one property, and other tenant information corresponding to said registered tenant;
a formatting module of said processing circuit configured and adapted to format said property information for said available property from a first format to a second format and having an input receiving said property in said first format and an output providing said property information in said second format as a common property listing for said available property;
a ranking module of said processing circuit configured and adapted to receive at least a portion of said property information and at least said offer data from a plurality of registered tenants, and to determine a ranked allocation of resources where said plurality of registered tenants compete for a same available property, said ranking module further being configured and adapted to provide an output representing a rank registered tenant list of registered tenants and properties;
a document generation module of said processing circuit configured and adapted to automatically output respective documents for each registered tenant allocating to them respective leases to corresponding respective properties on which they have successfully made offers; and
a real-time communication module of said processing circuit configured and adapted to send and receive negotiation messages in real time between a negotiating landlord and a negotiating tenant through said communication interface.
